(19) United States
(12) Patent Application Publication
(10) Pub. No.: US 2006/0247911 A1
(43) Pub. Date: Nov. 2, 2006

(54) Systems and methods for learning and mimicking the communications of intelligent electronic devices

(75) Inventor: David M. Nieuwsma, Moscow, ID (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Schweitzer Engineering Labs., Inc.

(21) Appl. No.: 11/116,195

(22) Filed: Apr. 28, 2005

(51) Int. Cl. G06F 9/455

(52) U.S. Cl. 703/27

(57) ABSTRACT

A computer system, software, and related methods for mimicking the communications of an intelligent electronic device (IED). The computer system at the direction of the software, contained therein, and the user communicates with an IED device by sending it commands. The computer system then records the commands and their corresponding responses from the IED. Subsequently, the user has the option of modifying the recorded responses. The user may then instruct the software to mimic the communications of the IED by returning the recorded responses when given the corresponding command.

### BACKGROUND OF THE INVENTION

The present invention generally relates to systems and methods for learning the serial or Ethernet communications of intelligent electronic devices (IEDs). More specifically, the present invention relates to systems, software, and methods for learning the communications of IEDs and for mimicking those communications in absence of the IEDs.

The computer software design and semiconductor industries have placed great importance on the quick and efficient design of both hardware and software systems. To aid both designers of hardware and designers of software the industries have developed emulators and simulators.

Generally, emulators duplicate or provide an emulation of the functions of another system. Emulators, typically, take the functionality of older computer systems or machines and run that functionality on a modern or target computer system in the form of a software emulator. A software emulator is computer software that allows certain computer programs to run on a computer system, architecture, or an operating system different from the one that originally executed the computer software.

By emulating older computer systems, the user can then run software associated with the older system on the target computer system. Frequently, emulation on target computer system is usually less cumbersome than relying on the original system, which may no longer be functional or practical. However, emulating newer or future systems may decrease the target system's overall performance.

Nonetheless, software emulators have several drawbacks. It is often difficult to construct an emulator that perfectly emulates an older system. This is mainly due to compatibility issues between the older system and the target system. In addition, the emulator designer may not be able to determine all of the functional aspects of the older system. Consequently, the designer may inadvertently leave out some important functions when creating the emulator.

In contrast, simulators imitate real devices, embedded systems, discrete state machines, or other states of affairs. Simulators are far more complex than emulators, as they not only imitate the functionality of a device but also try to imitate the underlying structure of the device. Simulators allow designers to construct and analyze a system and its capabilities, capacities, and behaviors without having to construct or experiment with a real system. Thus, simulators save time, effort, and money because it is extremely expensive to debug and to experiment with real devices, embedded systems, or, for example, a complex semiconductor.

Simulators are limited, though, in two distinct respects. First, simulators are limited by the ability of their designers to fabricate an accurate model of the system to be simulated. Real systems, especially digital systems, are extremely complex, and a determination must be made about the details that will be captured in the model. Some details must be omitted and their effects lost or they must be modified so that they can be aggregated with other variables which are used by the simulator. In the case of the semiconductors, for example, before any simulation can take place the designers must accurately create and model the underlying digital logic and, in some cases, the physical layout of the embedded transistors. These underlying designs must then be arduously programmed into the simulating environment.

In addition, practical simulating environments which are sufficiently able to test and analyze real devices, embedded systems, or discrete state machines, are very expensive. Many simulating environments are specially designed for a particular application. These systems are often large scale computer systems, which are controlled by large scale operating, testing, and analyzing software programs. Because these computer systems often utilize specialized hardware and software, these systems cannot be easily upgraded to perform more sophisticated simulations of advanced technology.

Generally, the preferred embodiment overcomes the deficiencies of conventional simulation and emulation in the context of IEDs by enabling the system to learn and recognize an IED's communications, providing customizable responses when mimicking an IED's communications, and by creating an environment that may be configured and executed on a typical personal computer.

The conventional emulation and simulation systems as discussed above, currently, do not provide an environment where the target system can learn the functionality from the actual system that will be imitated. In addition, a potential advantage of the present invention is that it overcomes the inability of the emulator designer to understand the complete functionality of the IED. Because the IED is linked to the computer system and the software used to create and control the environment, the system can monitor and learn all the other aspects of the communication, which occurs between it and the IED. The other aspects capable of being learned and stored as data by the invention include, for example, the time delay associated with amount of time an IED takes to respond to a particular command. As a result, a designer does not have to know or program every intimate detail associated with an IED's communications, and the system can learn from the IED.

An additional aspect of the present invention is that once this invention has learned the communications of an IED, it can save those communications as a record. A command and response record contains a known command, its response, and the other aspects associated with that command and response for a particular IED. When prompted with a specific command for an IED, the software will instruct the system to return the appropriate response along with the other associated aspects, thus, mimicking the communications of a particular IED.

Another aspect of the present invention is that a designer can customize the input commands and the responses for an IED, so that the system and software will be able to mimic the communications of an IED that has yet to be created. In this aspect, hardware and software designers can create and test “experimental devices” based on existing designs and devices. Thus, the designer saves time, effort, and money because he does not have to entirely create a new test environment for a new IED concept.

These and other desired benefits of the preferred embodiments of the invention, including combinations of features thereof, will become apparent from the following description. It will be understood, however, that a process or arrangement could still appropriate the claimed invention without accomplishing each and every one of these desired benefits, including those gleaned from the following description. The appended claims, not these desired benefits, define the subject matter of the invention. Any and all benefits are derived from the preferred embodiment of the invention, not necessarily the invention in general.

### SUMMARY OF THE INVENTION

The present invention is directed to a system, software, and methods for training a computer system to recognize the serial commands and responses of IED devices. The computer system is trained by directly interacting with the IED and by recording the IED's responses. Once the training of the system is complete, the computer system will then be able to mimic the IED from the serial communications point of view.

The present invention has three modes of operation: Learn Mode, Run Mode, and Terminal Mode. In Learn Mode, the system, at the direction of the software and the user, learns an IED's commands and its corresponding responses and/or signals to those commands. The system then stores these commands and responses as records. These records are editable and customizable by the user. Once a command and its associated response are stored, it can be mimicked by the system in Run Mode.

Run Mode is the mode in which the system mimics the communications of a particular IED. The IED need not be present for the system to operate in Run Mode; the user simply needs to instruct the system which IED to mimic. The system then searches the data storage for the command and response record linked to the IED entered by the user. After finding the record, the system replies to the input command by displaying or mimicking the response contained within the record.

Terminal Mode allows the user to directly interact with IEDs via serial or Telnet connections. The user may use the Terminal Mode in a manner similar to using a terminal program, such as Hyper Terminal, to send commands to the attached IED. The IED's responses to those commands are then returned to the terminal window provided by the present invention.

Each mode has several options available with it. These options carry out the functional aspects of the mode and allow the user to customize how the system will later mimic the communications of the IED. These features will be discussed in relation to the preferred embodiment.

### BRIEF DESCRIPTION OF THE DRAWINGS

FIG. 1 is a block diagram of a computer system used to mimic the communications of an IED.

FIG. 2 is a block diagram showing how the system is connected to an IED while operating in Learn Mode.

FIG. 3 is a flowchart diagram representing the steps performed during the initialization of the system and the steps performed by the software if the user selects SEND, ADD, or NEW while the software is operating in Learn Mode.

FIG. 4 is a flowchart diagram representing the steps performed by the software if the user selects EDIT while in Learn Mode and the steps performed by the software if the user selects SAVE or CANCEL while the software is operating in the Edit State.

FIG. 5 is a flowchart diagram representing the steps performed by the software if the user selects either DELETE or ADD NEW DATA SUBSTITUTION while the software is operating in Learn Mode.

FIG. 6 is a flowchart diagram representing the steps performed by the software if the user selects COPY TO IED, SELECT IED TYPE, or SELECT COMMAND while the software is operating in Learn Mode.

FIG. 7A is a flowchart diagram representing the steps performed by the software if the user selects EDIT COMMAND SETS while the software is operating in Learn Mode and the steps performed by the software if the user selects NEW, SAVE, CANCEL, or DELETE while the software is displaying the form to create or edit Command Sets.

FIG. 7B is a flowchart diagram representing the steps performed by the software if the user selects EDIT or CLOSE while the software is displaying the form to create or edit Command Sets.

FIG. 8 is a flowchart diagram representing the steps performed by the software if the user selects SEND COMMAND SET while the software is operating in Learn Mode.

FIG. 9 is a flowchart diagram representing the steps performed by the software if the user selects GET CAS COMMANDS while the software is operating in Learn Mode.

FIG. 10 is a flowchart diagram representing the steps performed by the software if the user selects GET HELP CMDS while the software is operating in Learn Mode

FIG. 11 is a screen capture showing the functions of the system in FIG. 1 while operating in Learn Mode and some of its features as demonstrated in FIGS. 3-6.

FIG. 12 is a screen capture showing the functions of the system in FIG. 1 while operating in Learn Mode and its features demonstrated in FIGS. 5 and 6.

FIG. 13 is a screen capture showing the functions of the system in FIG. 1 while in Learn Mode and its features in FIGS. 4 and 6.

FIG. 14 is a screen capture showing the functions of the system in FIG. 1 while in Learn Mode and its features in FIG. 4.

FIG. 15 is a screen capture showing the functions of the system in FIG. 1 while in Learn Mode and its features in FIG. 6.

FIG. 16 is a screen capture showing the functions of the system in FIG. 1 while operating in Learn Mode and the outcome of the operation depicted in FIG. 15.

FIG. 17 is a screen capture showing the functions of the system in FIG. 1 while operating in Learn Mode and its features demonstrated in FIG. 7A.

FIG. 18 is a screen capture showing the graphical user interface for creating and editing Command Sets as created by the system in FIG. 1 while operating in Learn Mode.

FIG. 19 is a screen capture showing the functions of the system depicted in FIG. 1 and its features as demonstrated in FIG. 10.

FIG. 20 is a screen capture showing the graphical user interface with the commands returned by the IED after it was issued a HELP command.

FIG. 21 is a block diagram showing how the system in FIG. 1 is connected to another computer, terminal, SCADA, etc. while the system is operating in Run Mode.

FIG. 22 is a flowchart diagram representing the steps performed during the initialization of the system in Run Mode and the steps performed by the software if the user enters commands for the system to mimic.

FIG. 23 is a flowchart diagram representing the steps performed by the software if the user instructs the system to send auto-messages.

FIG. 24 is a screen capture showing functions of the system in FIG. 1 while operating in Run Mode.

FIG. 25 is a screen capture of the Virtual Terminal, which may be utilized by the user in Run Mode.

FIG. 26 is a screen capture showing the underlining of the substitutions made in the RESPONSE text field.

FIG. 27 is a screen capture showing functions of the system in FIG. 1 while operating in Run Mode and the ADD DATA SUBSTITUTION feature as shown in FIG. 5.

FIG. 28 is a screen capture showing a graphical user interface presented to the user so that the user may enter values associated with a data substitution.

FIG. 29 is a screen capture showing a graphical user interface which allows the user to manipulate the values associated with the data substitution variables.

FIG. 30 is a screen capture showing the terminal window that the user may utilize while operating the system in Terminal Mode.

FIG. 31 is a block diagram showing how the system in FIG. 1 may be connected to an IED and another computer, terminal, SCADA, etc. for testing, demonstration, etc.

### DETAILED DESCRIPTION OF THE PREFERRED EMBODIMENT

FIG. 1 illustrates a system 100 adapted to learn the serial communications of an intelligent electronic devices (IEDs) 110 and mimic those serial communications by watching for recognized commands submitted by a user and then sending back to the user the appropriate responses. In general, the system 100 may be referred to as a data processing system, and typically represents a computing environment of a personal computer (PC); however, any environment with data storage 108, a processor or data processor 104, and a means for communicating with other devices 106 may suffice.

First, the system 100 preferably executes graphical user interface (GUI) software, shown in the form of learning-mimicking software 102, in a known manner. The learning-mimicking software 102 resides in memory and is executed by the processor 104. The system 100 operates and interacts with the user based on the instructions of the software 102. Consequently, the functionality and the operation of the system 100 and the software 102 will often be made in reference to only the learning-mimicking software 102.

In addition, those in the art will appreciate that the learning-mimicking software 102 may exist as single software program residing in memory or be separated into multiple software programs, each program being independently executed by the processor. Thus, the term software may also apply to more than one program that interacts with and instructs the system 100.

The learning-mimicking software 102 interacts with a user by means of input/output (I/O) devices 114. Typically, the user utilizes a keyboard and a mouse to input data and receives the output from the learning-mimicking software 102 on a monitor. The learning-mimicking software 102 preferably uses known programming routines and software techniques to permit the user to enter and receive data.

The system 100 is connected or attached 116 to the IED 110 such that the learning-mimicking software 102 interacts with an IED by way of either serial or Ethernet communications 106. Serial communications may be based on any asynchronous serial line protocol, for example, this embodiment uses EIA-232, while Ethernet communications may be based on the IEEE 802.3 protocol. However, communication between the learning-mimicking software 102 and the IED 110 may be accomplished by any other protocol or means.

The system 100 also includes a data storage mechanism 108 that permits the learning-mimicking software 102 to store, retrieve, copy, and delete data. This data may include, but is not limited to, IED information such as IED type, access level prompts, response for unrecognized information, etc.; command/response data such as IED type, command string, response string, delay, binary flag, minimum access level, type of response, flag for date/time substitution; data substitution information such as IED type, command string, data label, byte offset into response, number of digits for numeric substitution, data precision, default substitution value, etc.; optional tables for auto-message information such as an auto generated message caused by a system event detected by the IED; and optional tables for sets of IED commands. In addition, the data may include optional tables to keep track of user preferences such as serial port characteristics, last IED type selected, data storage file path, whether or not to highlight data substitutions, et cetera. The data associated with IED is stored in memory 102 and in data storage 108 using known data structures and database techniques. Those in the art will appreciate that the data storage 108 may be share among other computers, exist as part of the system 100 as demonstrated in FIG. 1, or may exist in computer system separate from but still in communication with the system 100.

The system 100 may also communicate 120 with other computers, SCADA, terminals, or devices 118 by means of serial or Ethernet communications 106. As a result, the system 100 may share its data storage or connect to an external data storage device. In addition, the system 100 can send and receive information from other systems 118. For example, these other systems 118 can receive the output of the software 102 when it is executed on the system 100.

The learning-mimicking software 102 provides an environment where the user can instruct the software 102 to learn the commands associated with a plurality of different IEDs and their respective responses. Within this environment, the user may choose which IED and which command and response records linked to that IED he wants to view, edit, or mimic. The user may also add or remove IEDs from the environment.

The learning-mimicking software 102 has three main modes of operation: Learn Mode, Run Mode, and Terminal Mode. Each of these modes of operation will be discussed in turn.

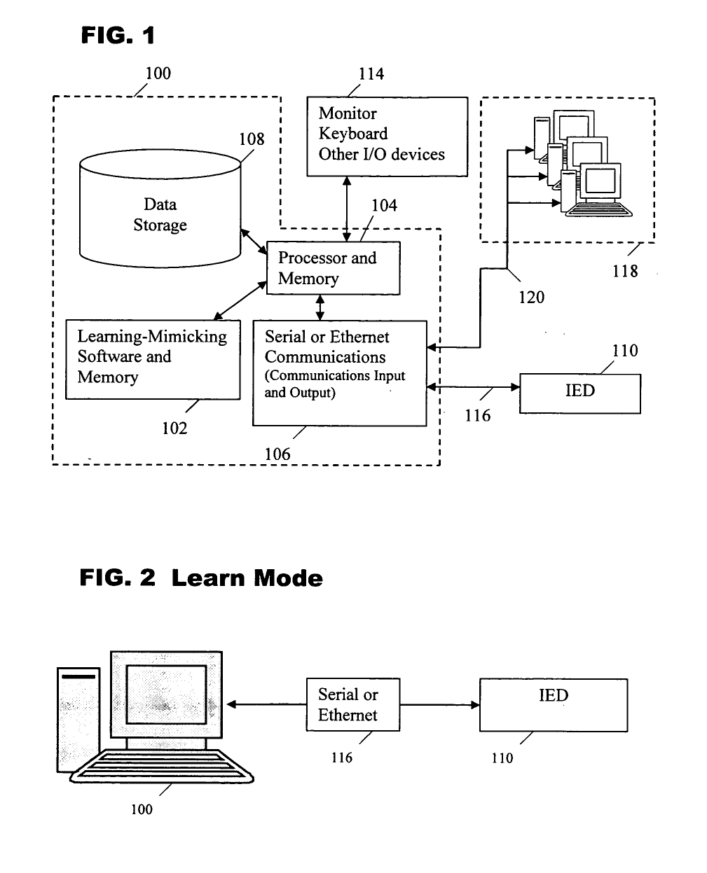

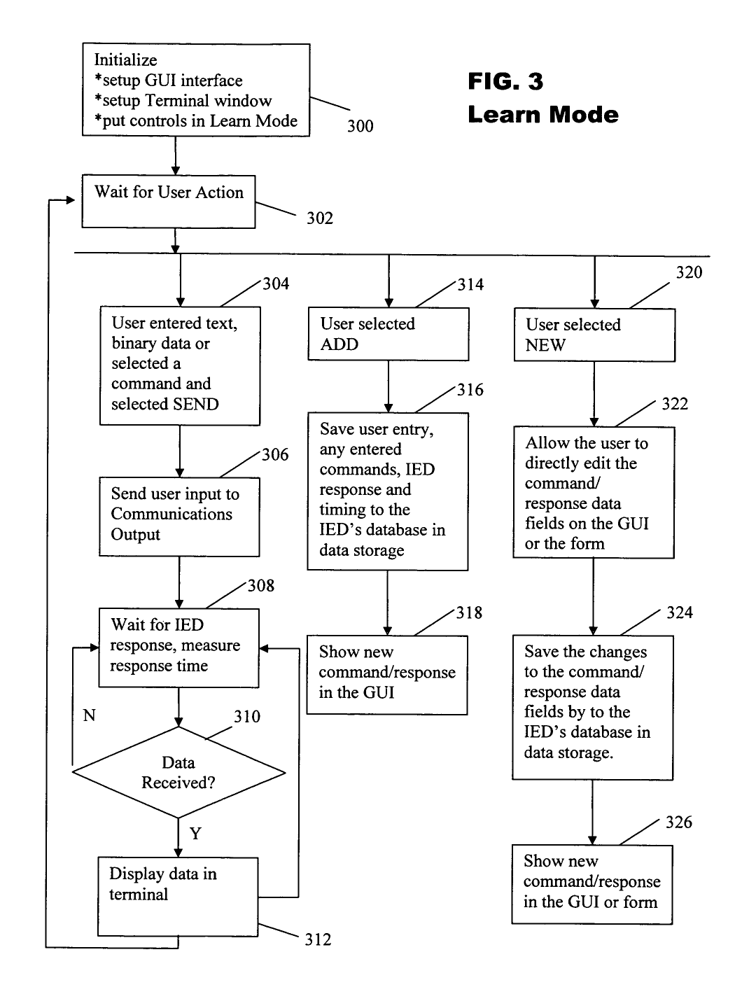

Learn Mode provides a mechanism for training the software 102 to recognize the commands and communications with an attached IED 110 and to learn responses by the IED 110 to those commands. This connection between the system 100, which is executing the learning-mimicking software 102, and an IED 110 by way of serial or Ethernet communications 116 is generally shown in FIG. 2.

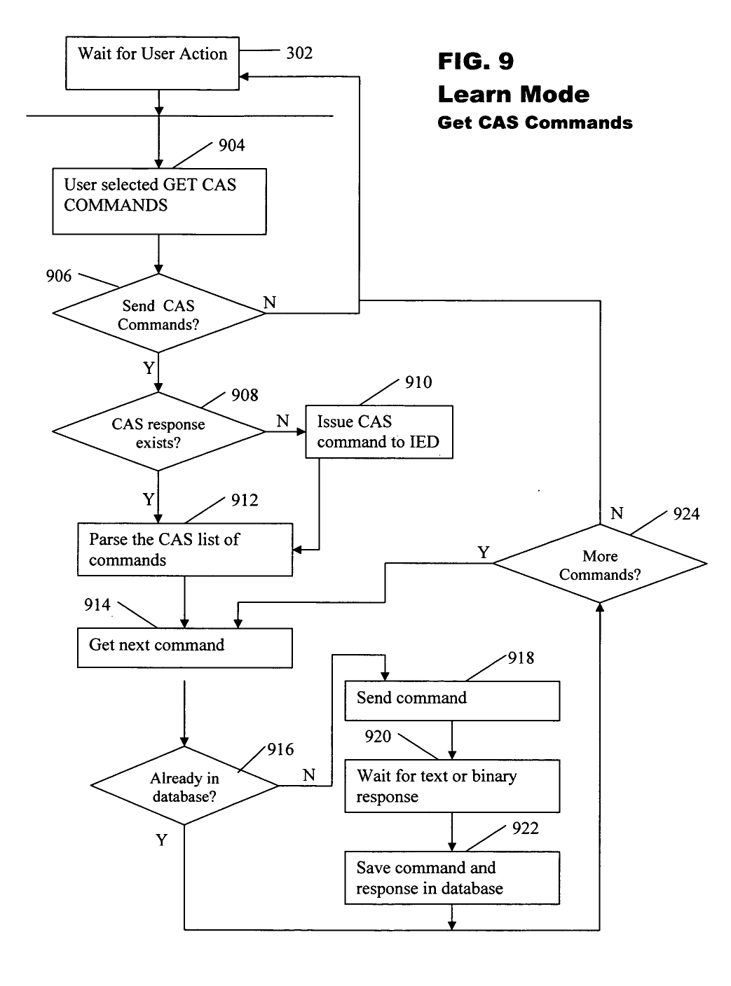

FIGS. 3, 4, 5, 6, 7A, 7B, 8, 9, and 10 demonstrate different aspects of how a user might interact with the learning-mimicking software 102 while it is operating in Learn Mode. It should be understood, though, that not all of the operations or interactions are necessary for the operation of the invention and that the following description represents those features available in the preferred embodiment.

In FIG. 3, the user first initializes 300 the learning-mimicking software 102 by turning on the computer. The user then executes the learning-mimicking software 102, which sets up the graphical user interface and places the learning-mimicking software 102 in Run Mode, which is its default mode. The user may then place the software 102 in Learn Mode by selecting the LEARN MODE option.

The learning-mimicking software 102 then waits in Learn Mode for user input 302. The user may interact in several ways with the learning-mimicking software 102 while the software 102 is operating in Learn Mode. First, the user may enter or select single commands using the GUI for transmission to the IED. For example, the user may enter text or binary data 304 representing commands into the appropriate fields and select SEND. The learning-mimicking software 102 then sends the user's input to the communications output 306, which transfers the user's input to the IED 110. The software 102 then waits for the IED's response to the user's input 308 and measures the IED's response time. Once the response data is received 310 from the IED, the learning-mimicking software 102 displays a representation of that response to the user in a known manner 312, such as displaying the representation in a text field within a GUI. This response data may then be saved or modified by other options. The learning-mimicking software 102 continues the cycle of waiting 308, receiving 310, and displaying 312 until the user is satisfied that the IED 110 has stopped responding to the user initiated command. The software 102 then waits 302 until the user selects another option.

The user may also select the ADD 314 option. The software 102 then saves to data storage 108 the user's input, the entered command, the IED's response, the timing data, and other associated data 316. The saved command, response, and data forms the basis of a new command and response record that the learning-mimicking software 102 will later mimic when the software 102 is placed in Run Mode. The software 102 then displays 318 to the user that the saved information has created a new command and response record in the IED's database in data storage 108.

It is not necessary for the learning-mimicking software 102 to learn from an attached IED. The user may directly add and edit new records for command and response combinations by selecting the NEW 320 option. This option allows the user to directly edit the command and response data fields on the GUI 322. After editing the fields, the user may save the information as a command and response record. As described above, the software then saves 324 the information in the data fields to the data storage 108. The software 102 then displays 326 to the user that the saved information has created a new command and response record in the IED's database in data storage 108.

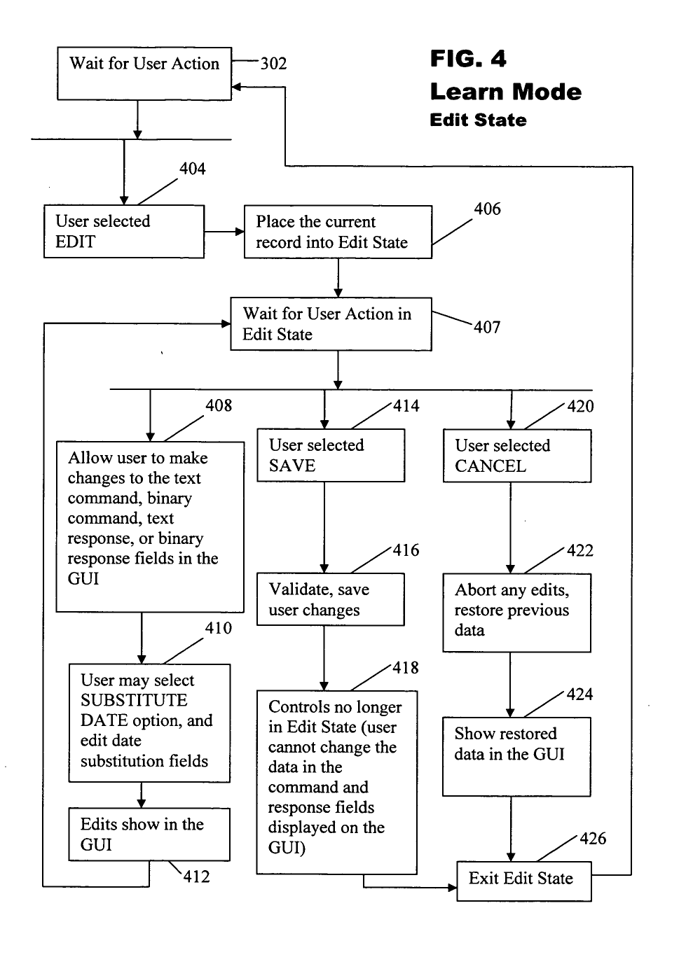

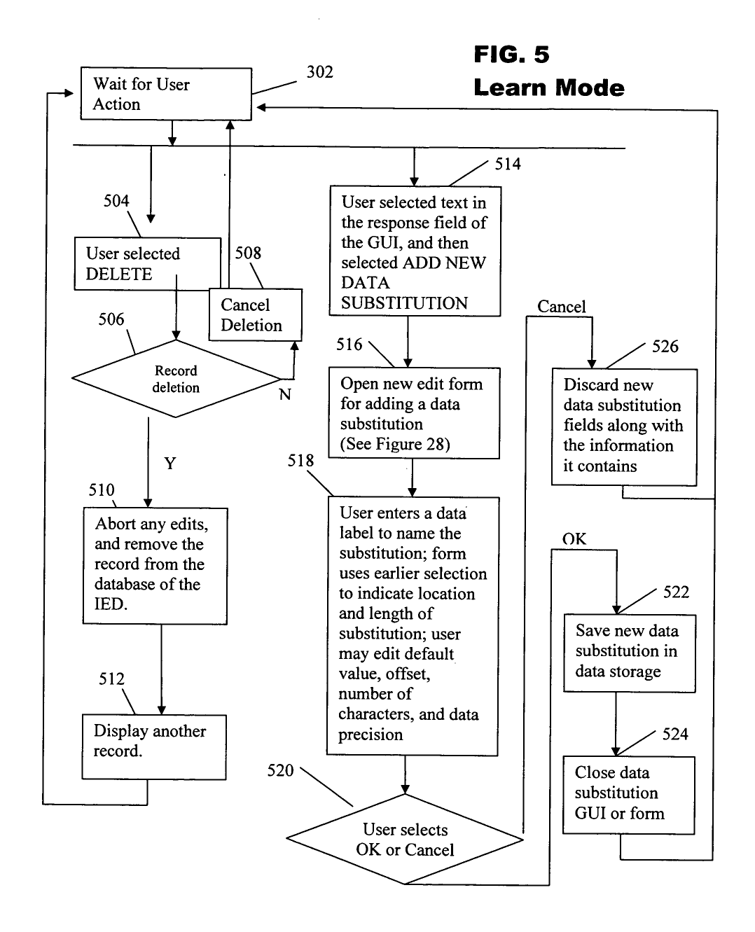

As FIG. 4 demonstrates, the user may also select EDIT 404. In this case, the learning-mimicking software 102 places the command and response record being currently viewed by the user into Edit State. Edit State allows the user to make changes or modify text fields, the binary data field, or the data corresponding to the response from the IED, all at 408 in FIG. 4. The user may want to substitute the system's current date and time for the date and time in the response. To accomplish this, the user may modify the date field in the response by selecting the SUBSTITUTE DATE 410 option. The software 102 then displays the edits made by the user 412. The software then waits 407 for the user to select an option or make additional modifications.

In Edit State, the software waits 407 for the user to make any changes to the editable fields 408 in the GUI or to initiate an action that exits the Edit State. The user may store his edits in a command and response record and exit the Edit State by selecting the SAVE 414 option. The software 102 validates the user's changes to the command and response data and then saves 416 the data as a command and response record in the IED's database in data storage 108. If the database in data storage 108 contains a prior record for the edited command, that record is replaced by the edited version. The software 102 then exits out of the Edit State 418 and returns to waiting for an action by the user 302.

While in Edit State, the user may also select the CANCEL 420 option. The software 102 then aborts any edits the user may have made while in Edit State and restores any previous information or data 422. Subsequently, the software 102 shows the restored data to the user 424, exits out of Edit State 426, and returns to waiting 302 for user input.

A user may also permanently remove a record from data storage 108 by selecting the DELETE 504 option as shown in FIG. 5. When the user selects this option, the software 102 opens a dialog box 506 asking the user to confirm whether he wants to proceed with the DELETE option. If the user selects NO, the deletion routine is canceled 508, and the program returns to waiting for an action by the user 302. If the user continues with the deletion routine, the learning-mimicking software 102 aborts any edits that user instituted and removes the presently displayed record from the database of the IED 510. The software 102 then displays another record 512 and goes back to wait for an action by the user 302.

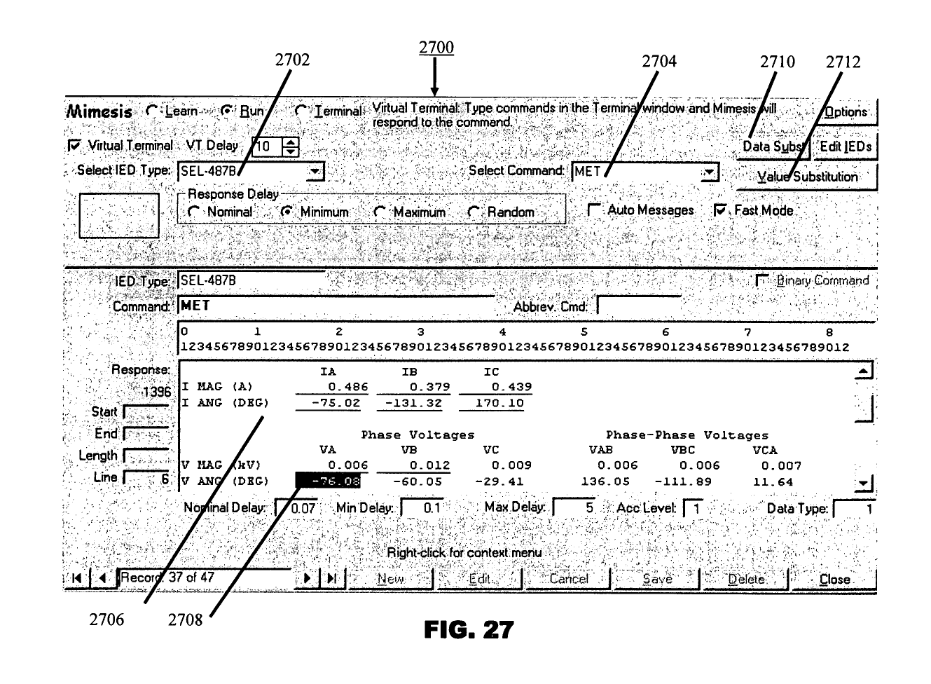

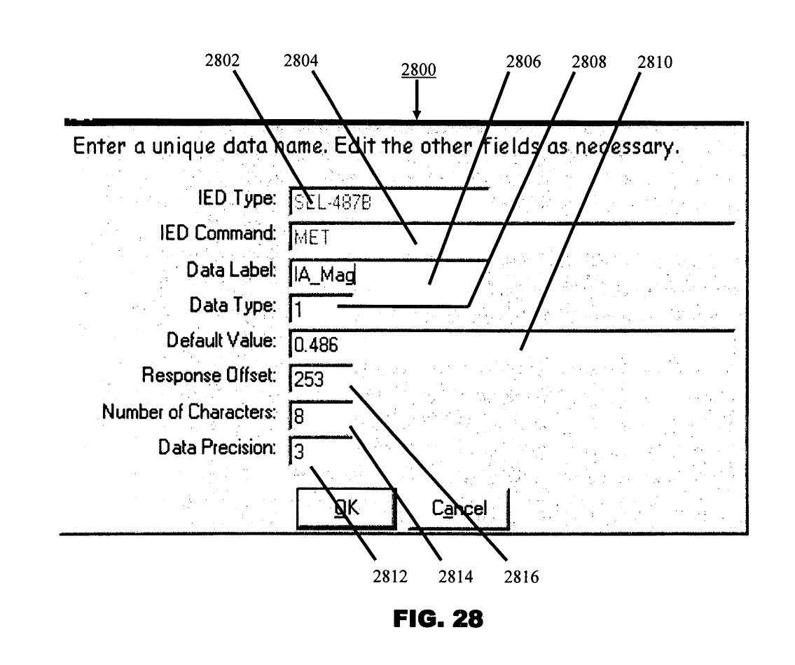

FIG. 5 also demonstrates the data substitutions in the response fields. A user may modify an IED's response data by first selecting text to replace in the response data field (see FIG. 27) and then selecting ADD NEW DATA SUBSTITUTION 514. Subsequently, the software 102 opens an edit window, such as a new editable form or GUI 516 (an example of which is shown in FIG. 28). The editor uses the earlier selected text to indicate to the user which command is having its response modified and the allowable length and type of the data substitution 518. The user then enters a data label to name the substitution. The user may edit any of the fields of the edit window, for example, the data type, the default value, the offset, number of characters, and the numerical precision of the IED's response data 518. The user may then accept or reject the information contained within the edit window 520. If the user accepts the information contained within the edit window, the software 102 then saves 522 the new data edited by the user in data storage and closes the GUI 524. If the user rejects the data by selecting CANCEL, then the software 102 discards the data edited by the user and closes the GUI 526. Once the window is closed, the learning-mimicking software 102 returns to waiting for an action by the user 302.

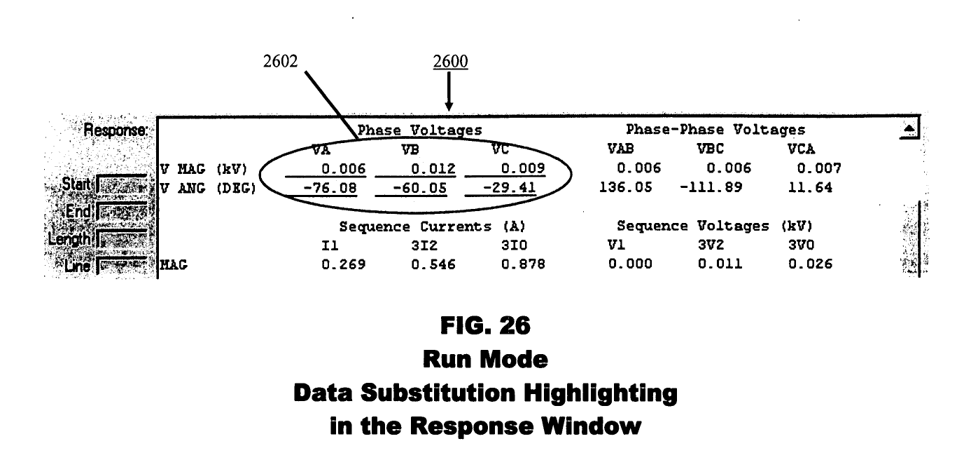

Data substitutions may take place in either Learn Mode or Run Mode. Data substitutions allow the user to replace specific values in the response data. The user may then modify these values, which in turn, modifies the values return in the response. Thus, the user may customize the mimicked response by software 102 by adding data substitutions, which are indicated by underlying or highlighting, into the response fields (See FIG. 26).

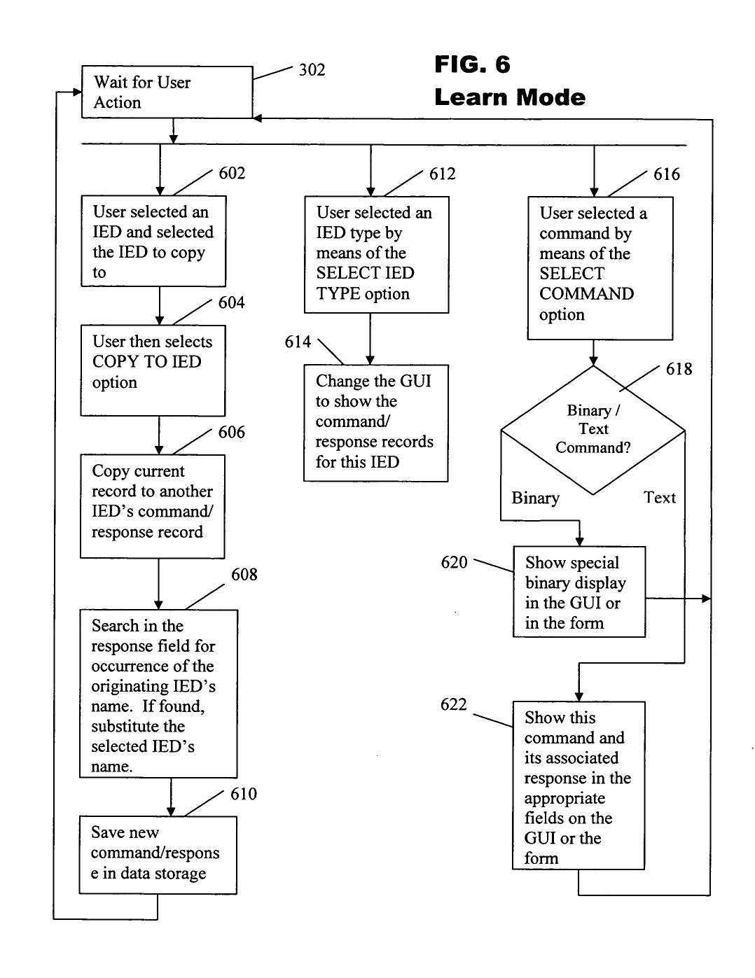

As shown in FIG. 6 the user may copy command and response records by utilizing the COPY TO IED option 604. First, the user must select the IED to copy to from the drop down menu 602. Then user may select the COPY TO IED 604 option. After the user makes this selection, the software 102 copies the record for the command and response combination currently displayed to the user 606. The learning-mimicking software 102 then searches 608 the response of field of the record to be copied for the originating IED's name. If the old IED name is found, it is replaced with the new IED name. The copied command and modified response fields are saved in the data storage 610. The command and response record is then associated with this selected IED. The user may modify the record by selecting the EDIT 404 option and starting the Edit State. Once the changes are made, the user may save the changes in data storage 108 by selecting the SAVE 414 option after selecting EDIT 404 from 302 as shown in FIG. 4.

A user may also view IED information and modify the records of different IEDs by selecting the IED's name or IED type from a list of IEDs 612. The learning-mimicking software 102 then displays the records which are linked with that IED type 614. The IED type is an identifier and serves to separate IED records within data storage so the software 102 may store records for plurality of different IEDs. The command and response records are linked to specific IED because each record is associated with an IED type.

A user may also select a different command and response combination among those associated with current IED displayed to the user 616. The user may select either a binary command or a text command 618 that was stored previously or by any of the add methods such as COPY TO IED, HELP, CAS, and Command Set. If the user selects a binary command, the software 102 then displays to the user the command and its respective response in a special binary display 620. If the user selects a text command, the software 102 shows this command and its response in the appropriate fields of a GUI or a form 622.

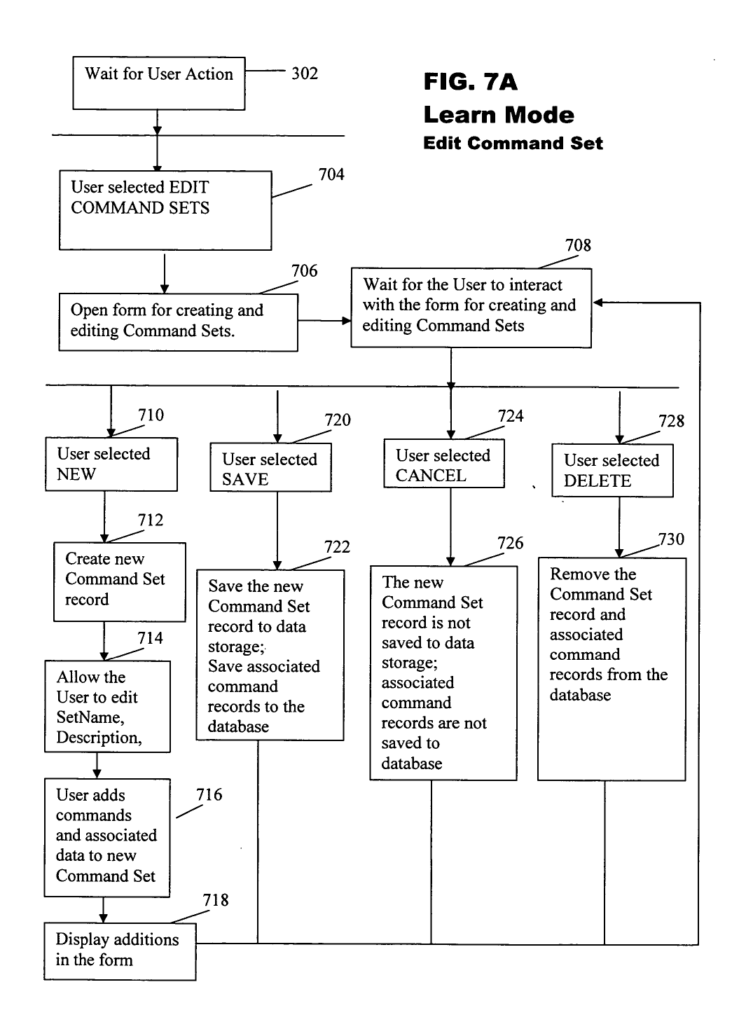

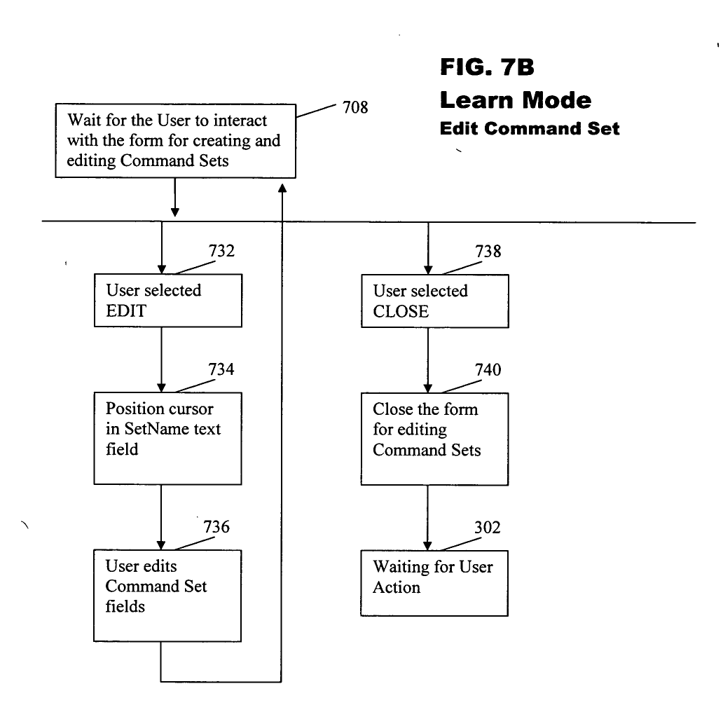

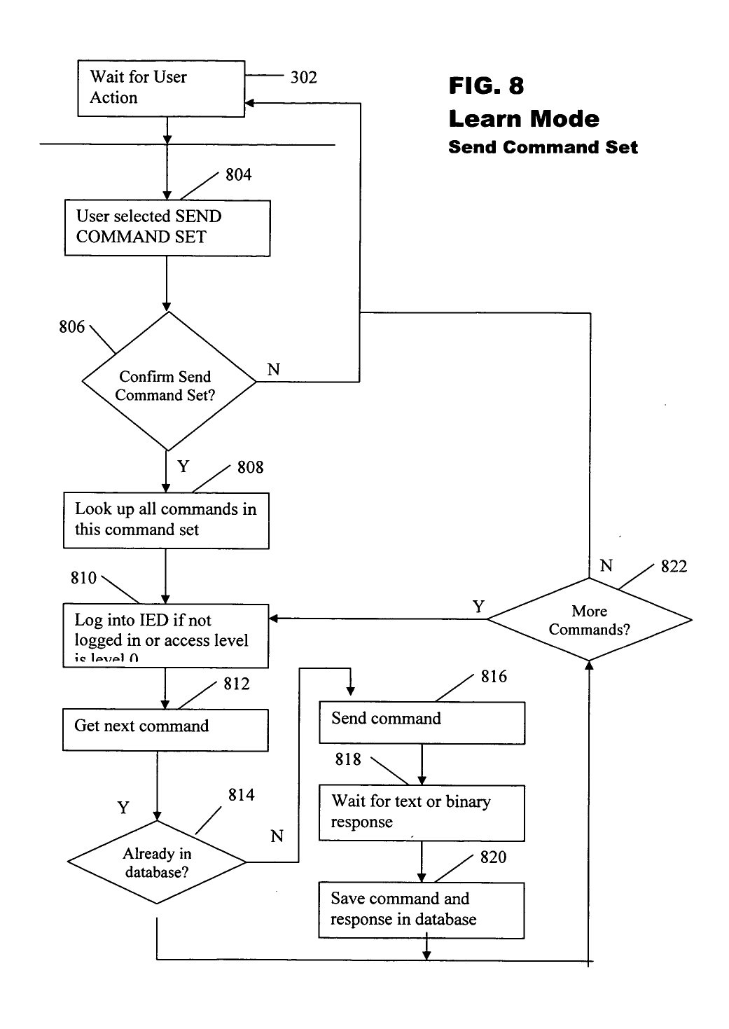

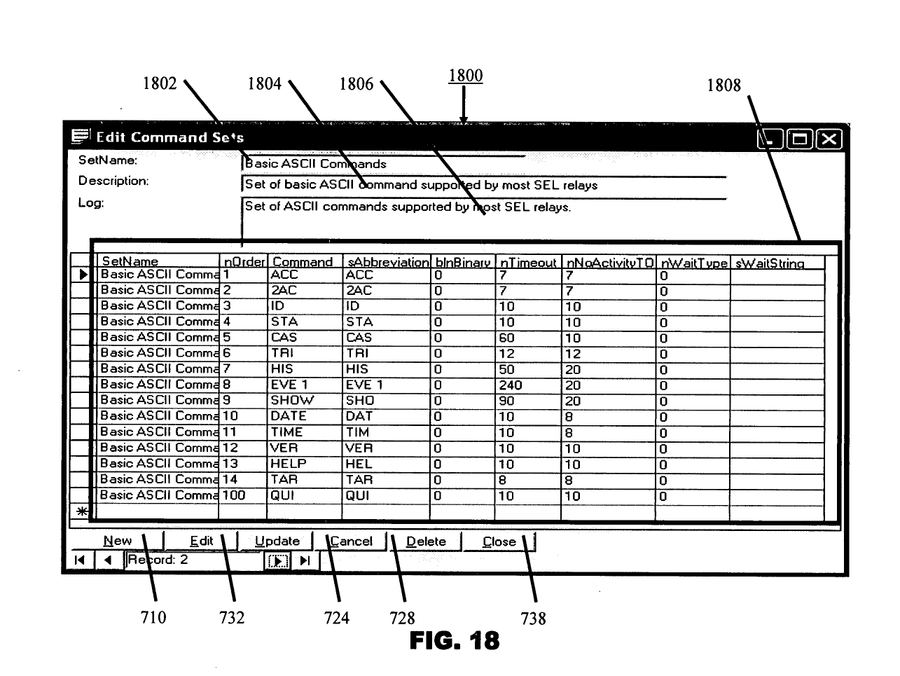

A user may also elect to send a collection of commands to the connected IED and automatically record the IED's successive responses. FIGS. 7A and 7B demonstrate how to create a list of these commands. First, a user must construct a list of commands by selecting the EDIT COMMAND SETS 704 option. The software 102 then opens a graphical user interface (hereinafter referred to as the Edit Command Sets GUI an example of which is demonstrated in FIG. 18) for creating and editing a list of commands, called a Command Set 706. The software 102 then waits for the user to interact with this graphical user interface.

The user may create a new Command Set by selecting the NEW 710 option. After selecting this option, the software 102 creates a new Command Set record 712. The user may then edit the fields within this record such as the SetName text field, the Description text field, and the Log text field 714. The User may then add commands and associated data 716 to the list created by the NEW 710 option. The software 102 then returns to waiting for the user to interact with the Edit Command Set GUI 708.

The user may save the Command Set created by using the NEW 710 option by selecting the SAVE 720 option. After selecting the SAVE 720 option, the software 102 saves 722 the Command Set to the data storage 108. The software then returns to waiting for user interaction 708.

If the user no long wishes to continue to create a Command Set, the user may use the CANCEL 724 option. The software 102 then will not save any of the information entered or modified by the user. The software 102 then returns to waiting for user interaction 708. To remove a Command Set from the database, the user may use the DELETE 728 option. The software 102 then removes 730 the Command Set selected by the user and its associated command records from the database in data storage 108. The software 102 then returns to waiting for user interaction 708.

FIG. 7B demonstrates how a user may edit the fields within the Edit Command Set GUI or close the interface. A user may select the EDIT 732 option. This option allows the user to edit the text fields within the Edit Command Set GUI and allows the user to edit the commands and their associated data in the Command Set. After the user selects the EDIT 732 option, the user is able to edit the SetName text field 734. The user may then move to and edit any of the text fields or commands 736. Once the user is finished editing, the software 102 returns to waiting for user interaction within the Edit Command Set GUI 708.

The user may close the Edit Command Set and return to the main graphical user interface by selecting the CLOSE 738 option. The software then closes the Edit Command Set GUI and returns to waiting for user interaction within the main graphical interface 302.

After returning to the main graphical user interface, the user may select the SEND COMMAND SET 804 option. At this point the user may select a series of commands to send to the IED with timeout values, or load a set of commands previously entered using the EDIT COMMAND SET 704 option. After selecting the set of commands to send, the user may then select SEND COMMAND SET 804. The learning-mimicking software 102 then asks for confirmation from the user to send the set of commands to the IED 806. If the user denies confirmation, the software 102 returns to waiting for user input 302. However, if the user gives confirmation, then the software 102 looks up all the commands in the Command Set. The software 102 then connects to the IED through the communications port and logs into the IED 810. After connecting to the IED, the software 102 retrieves the first command 812 from the set or list. The learning-mimicking software 102 then determines whether that command was previously added to the database of command and response records 814 for the IED attached to the system. If the command is present in the database, the software 102 will not send the command to the IED. The system will then determine whether there are any more commands in the command set 822.

If the first command was not previously stored in the database, the software 102 will send the command to the attached IED 816. The learning-mimicking software 102 will then wait for a text or binary response from the IED 818. The learning-mimicking software 102 then saves 820 the record of the command and its response to the database for the attached IED in data storage 108. The software 102 then determines whether there are any more commands 822. If there are more commands, if necessary the software 102 logs in to the IED 810 and continues the above process. Once the final command is entered and the above process is completed, the learning-mimicking software 102 returns to waiting 302 for an action by the user.

The user may also “teach” the learning-mimicking software 102 by entering a string of CAS commands as shown in FIG. 9. The acronym CAS stands for “compressed ASCII”. Some IEDs support CAS commands and, therefore, will respond when they receive such a command. First, a user may select GET CAS COMMANDS 904 option. The GET CAS COMMANDS 904 option issues a specialized CAS command which retrieves a list of all CAS commands available for the attached IED. The software 102 asks for confirmation from the user as to whether the user wants to send the CAS command 906. If the user denies confirmation, the program then returns to waiting for user input 302.

If the user opts to send the CAS command, the software 102 will determine whether there is an existing CAS response 908. If the software 102 does not find a CAS response, the software 102 will then issue the CAS command to the IED 910 and parses the CAS list of commands 912. However, if the software 102 finds a CAS response exists, then the software 102 will only parse the CAS list of commands 912. Subsequently, the software 102 retrieves the first CAS command from the list 914. The learning-mimicking software 102 then determines whether that command is already associated with the IED being tested 916 by searching the IED's database in data storage 108 for a record of the command and its response. If the command and its response are contained in a record, then the software 102 determines if there are any more CAS commands to send to the IED 924.

If the CAS command is not associated with a record in the database, then the software 102 sends the command to the IED 918 via the communications port. The learning-mimicking software 102 then waits 920 for a response from the IED. Once it receives the complete response from the IED, the software 102 creates a record of the command and response combination 922 in data storage 108 and associates that record with the IED. The software 102 then determines if there are any more commands to send to the IED 924. If there are any more CAS commands, the software 102 retrieves the next command 914 and continues with the aforementioned process.

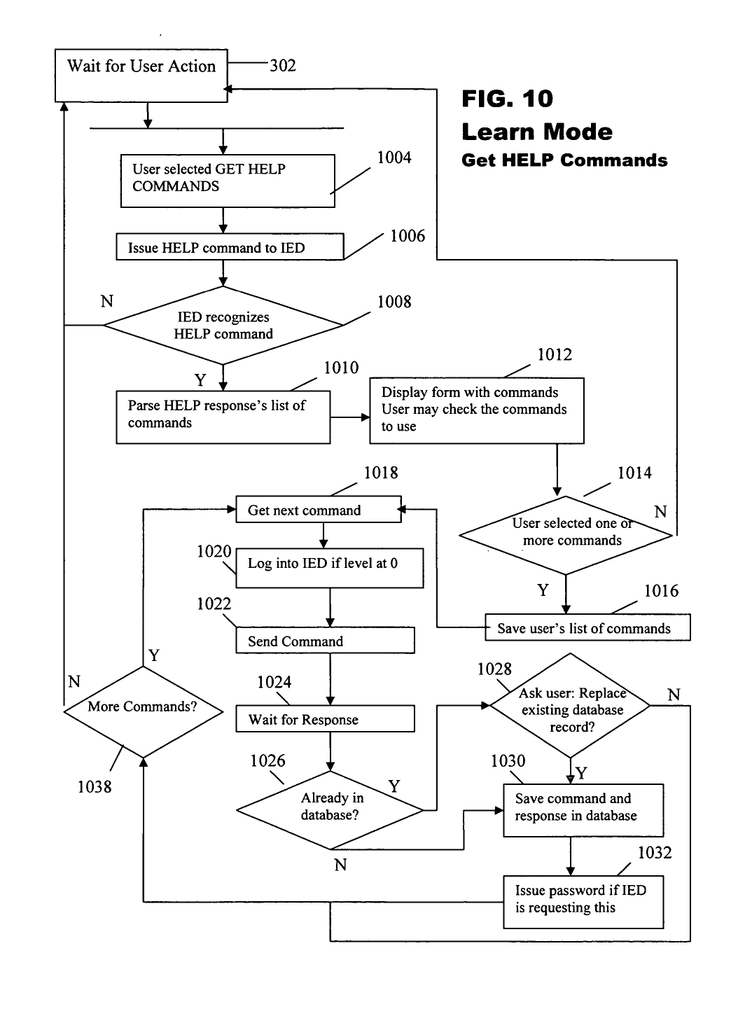

FIG. 10 demonstrates how the user may utilize the GET HELP CMNDS 1004 option to retrieve a list of commands from the attached IED. First, the user must select the GET HELP CMNDS 1004 option. The software will then send a HELP command 1006 to the attached IED 110. Many IEDs are designed to respond to this HELP command by returning a list of all the commands recognized by that IED. By examining the response, the software 102 will determine if the attached IED 110 recognizes the HELP command 1008 it received from the software 102. If the IED did not recognize the HELP command, the software 102 will return to waiting for user interaction 302.

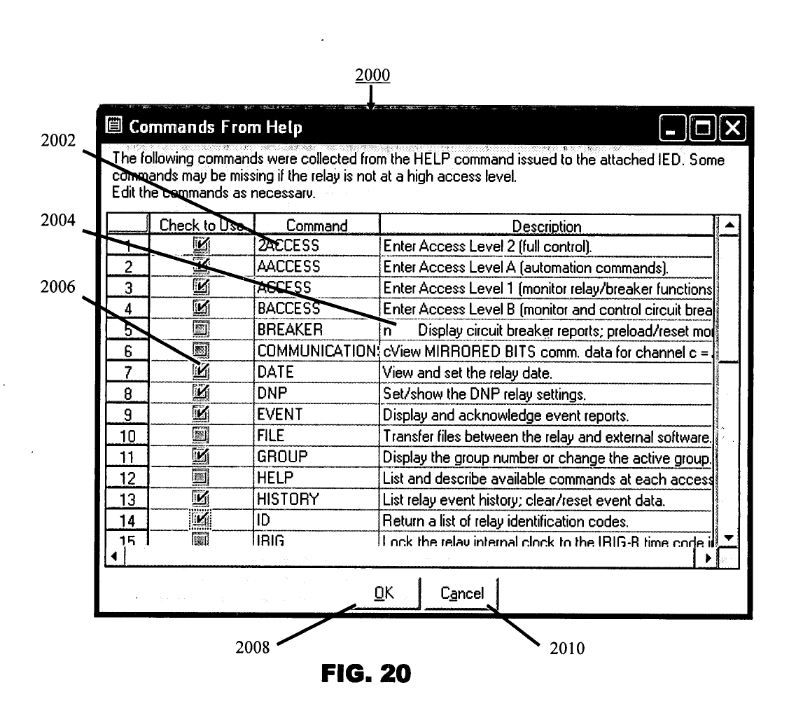

If IED did recognize the HELP command, the IED will return a list of commands along with short description of each command. The software 102 will then parse this list of commands 1010. After parsing the list, the software 102 will display a graphical user interface with a list of the parsed commands 1012 shown in FIG. 20. The user may then check which commands to send 1012 to the attached IED. The software 102 will then determine whether the user selected one or more of the commands 1014. If the user does not select any of the commands in the graphical user interface, the software will close the graphical user interface and return to waiting for user interaction with the main interface 302.

If the user selected one or more commands from the list, the software 102 then will save the user's list of commands 1016. The software 102 will retrieve the first command from the saved list of commands 1018. If necessary, the software 102 will log in to the IED 1020. The software will then send 1022 the command to the IED. The software then waits for a response from the IED 1024. After receiving a response, the software 102 will determine whether the command and response combination is stored in the database for the attached IED 1026. If the command and response combination is not in the database, the software 102 will save 1030 the command and response as a record in the IED's database in data storage 108. If necessary, the software will issue a password to the IED 1032 to go to a higher access level 1020.

If the command and response combination was previously stored as a record, the software will ask the user if he wants to replace the existing database record with the new command and response combination 1028. If user agrees, the software 102 will save 1030 the command and response combination over the existing record in the IED's database. Afterwards, the software will issue a password to the IED 1032 if the IED is requesting a password 1032.

After the command and response combination has been saved or after the user declines to overwrite the existing record, the software 102 will determine whether there are any more commands in the saved list of commands selected by the user 1038. If there are more commands, the software will retrieve the next command from the list 1018 and the above described process will continue. If there are no more commands in the list, software 102 will return to waiting for user interaction 302.

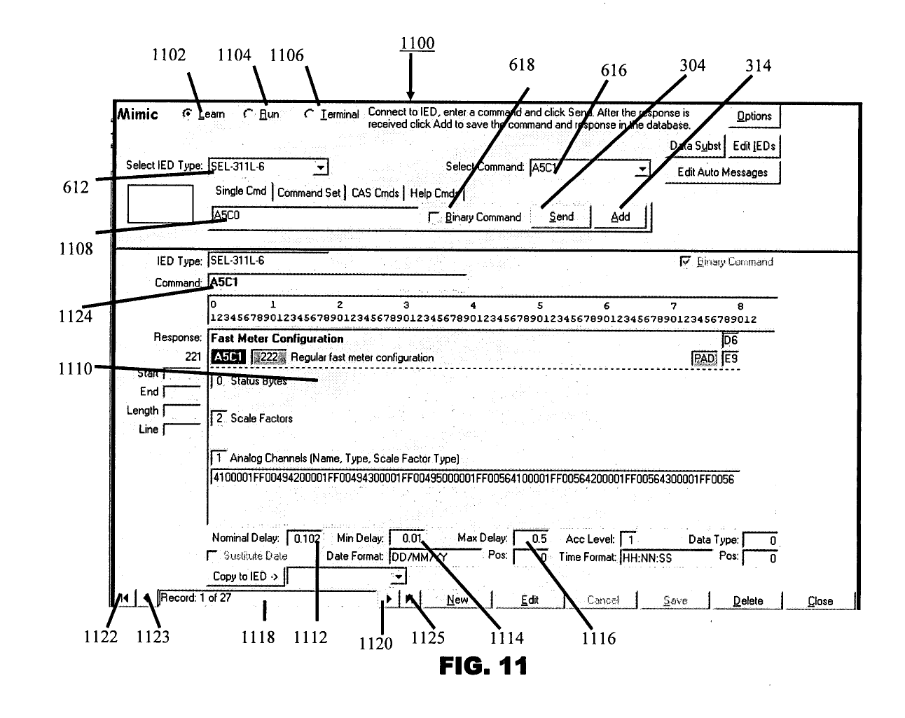

FIGS. 11-20 are examples of graphical user interfaces (GUIs) presented to the user in Learn Mode. These figures also demonstrate how the learning-mimicking software 102 operates in Learn Mode and how the user may utilize the options available in Learn Mode. The GUI or form 1100 is presented to the user when he initializes the learning-mimicking software 102. The user may then select among the three modes of operation: Learn Mode 1102, Run Mode 1104, and Terminal Mode 1106. In this example, FIG. 11, the user has chosen to operate the program in Learn Mode. The user may then select which IED type he wants to manipulate, edit command and response combinations, add records of command and response combinations, et cetera by using the drop down menu for the SELECT IED TYPE 612 option. In FIG. 11, for example, the user has selected to manipulate the records associated with IED labeled SEL-311L-6. The user may then select a specific command and response record associated with this IED by using the drop down menu for the SELECT COMMAND 616 option. The drop down menu linked to the SELECT COMMAND 616 option displays the commands that have been saved in data storage and are associated with the selected IED. The command then also appears in the 1124 text field.

The graphical user interface also allows the user to view commands and responses stored in data storage. To view the commands and responses, first, the user must select a command from the drop down menu for the SELECT COMMAND 616 option. After the user selects the command, the software 102 displays the command's corresponding response in the RESPONSE field 1110.

The user may send a new command to the attached IED by means of the SEND 304 option. First, the user enters the command into the appropriate field 1108. The user then selects whether the command should be transmitted to the IED in a binary format or in an ASCII format. The default format is ASCII, in which case the command is sent to the IED as set of ASCII characters. If the user wishes to send the command in a binary format, then he must select the BINARY COMMAND 618 option. The software 102 then sends the command to the connected IED 110 by way of the communications port 106. The software 102 then waits to receive a response from the IED by way of the communications port 106. While waiting for the response, the learning-mimicking software 102 measures the IED's response time. The resulting response time may be used to determine the value of nominal 1112, minimum 1114, and maximum delay 1116.

At some point the IED finishes responding to the command and the response is displayed in the Terminal. Afterwards, the user may select the ADD 314 option to create a command and response record, which is saved in the data storage and is associated with the IED type displayed in the SELECT IED TYPE 612 drop down menu. The command will then appear in the drop down menu for the SELECT COMMAND 616 option. When the user selects the command, its corresponding response will be displayed in the RESPONSE field 1110. The fields for command, response, et cetera are shown.

The user is not limited to entering or selecting commands by means of the ENTER COMMAND 1108 text field or the SELECT COMMAND 616 drop down menu. The display field 1118 presents the user with information about how many records are associated with the selected IED type and the position within those records held by the currently viewed command. In FIG. 11, for example, the command “A5C1” is the first of twenty-seven commands that are currently associated with the SEL-311L-6 IED type. A user may view different records of command and response combinations associated with the IED type in succession by utilizing the backward 1123 or “go to first” controls 1122 and the forward 1120 or “go to last” controls 1125.

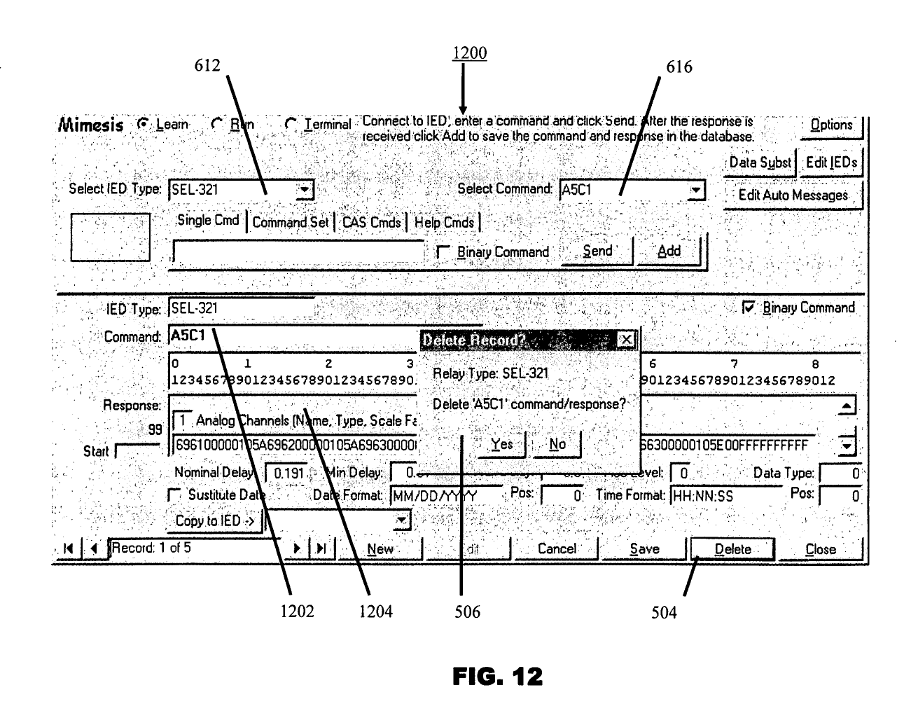

It is not necessary for this invention to learn from an attached IED. The user may directly add, delete and edit records for command and response combinations. FIG. 12 shows the deletion of the “A5C1” command and response record from the SEL-321 IED database. After selecting the SEL-321 type from the SELECT IED TYPE 612 option, the user has selected the “A5C1” command from the drop down menu of the SELECT COMMAND 616 option. Subsequently, the learning-mimicking software 102 displayed the command and the associated response in their respective COMMAND field 1202 and RESPONSE field 1204. The user then selected the DELETE 504 option. The software 102 then asked the user for confirmation of the deletion 506. If the user decides to cancel deletion by selecting NO, the learning-mimicking software 102 will cancel the deletion process and continue normal operations. If the user selects YES, the software 102 will delete record containing the “A5C1” command and its response from the records associated with the SEL-321 IED. Consequently, the “A5C1” command will be removed from the SELECT COMMAND 616 drop down menu.

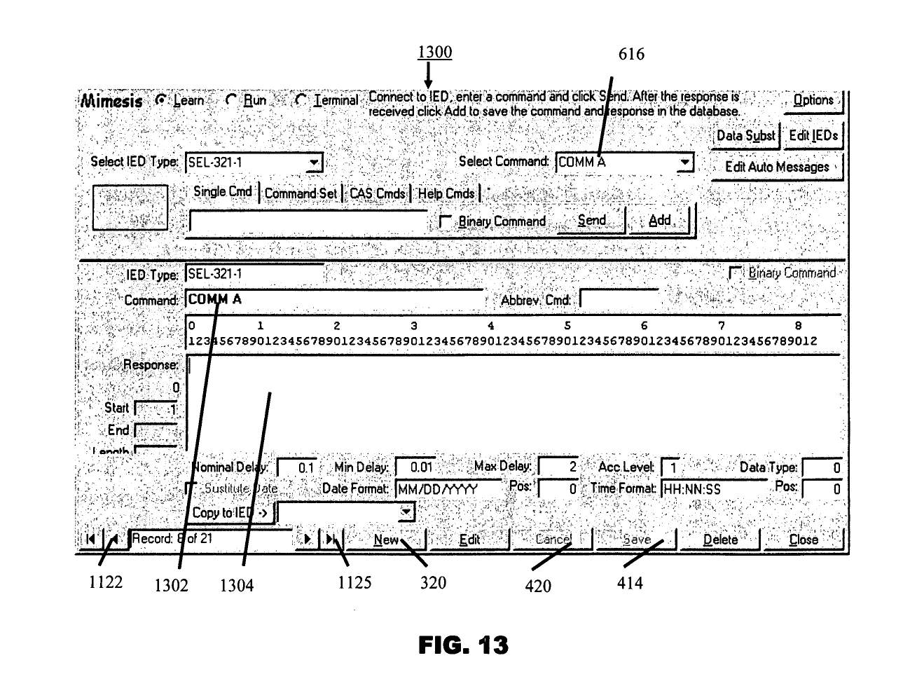

FIG. 13 demonstrates how to generate a new record for a command and response combination without connecting to an external IED. In this example, the user is adding a record for the command “COMM A” to the database of the SEL-321-1 IED. First, the user selected the NEW 302 option. By selecting this option, the learning-mimicking software 102 allows the user to edit the COMMAND 1302 and RESPONSE 1304 fields of the GUI 1300. The user may edit those fields and then create a new record by selecting the SAVE 414 option. The software 102 will then create a record for the “COMM A” command and the response, which was entered by the user. In addition, the command “COMM A” will appear in the SELECT COMMAND 616 drop down menu.

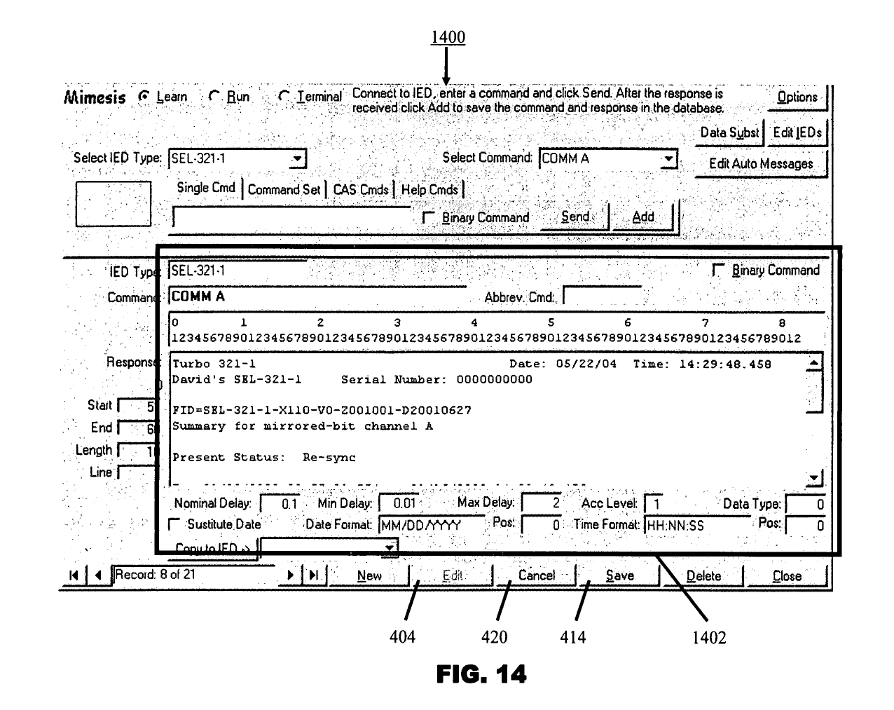

As demonstrated in FIG. 14 and the GUI 1400 presented to the user, the user may also select the EDIT 404 option. After selecting the EDIT 404 option, the software 102 enters into the Edit state. The user may then change any of the fields 1402 related to the command and response record. Following the modifications, the user may save the record using the SAVE 414 option. If the user wants to restore the fields 1402 to their original values, then he may select the CANCEL 420 option. The CANCEL 420 option will abort any edits and restore the fields 1402 to their previous values.

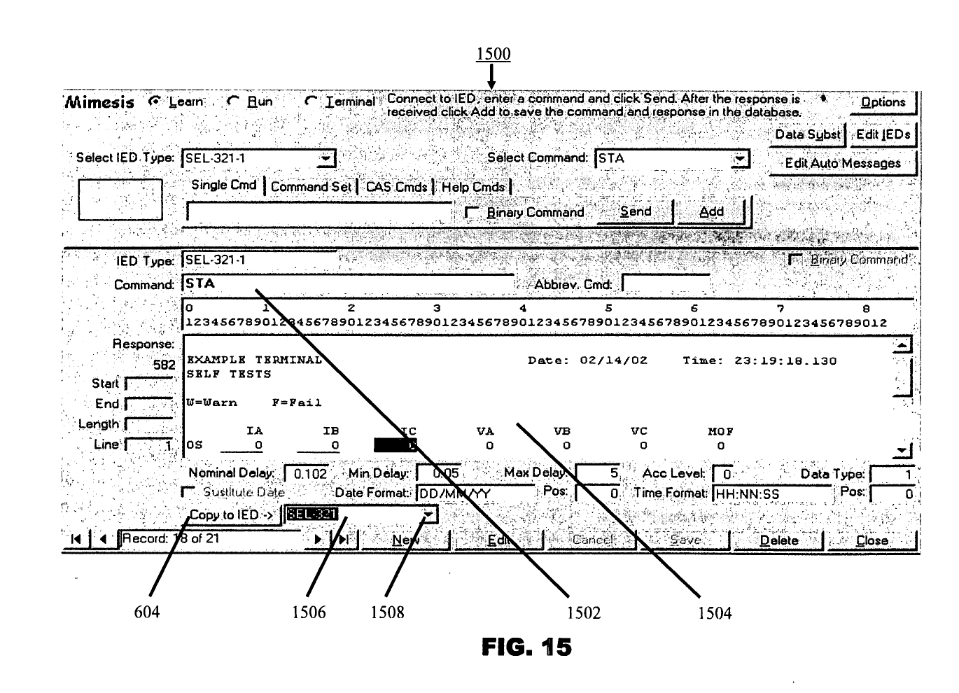

Additionally, the user may create command and response records for other IEDs by copying the stored command and response record associated with one IED to a record associated with another IED. This may be accomplished by using the COPY TO IED 604 option as demonstrated by the GUI 1500 in FIG. 15. First, the user selects a command and response record for the originating IED. In FIG. 15, the user has selected the “STA” command (as shown in the COMMAND text field 1502) for the SEL-321-1 IED. The command's associated response for the SEL-321-1 IED is shown in the RESPONSE field 1504. The user must then either enter an existing IED in the COPY TO IED text field 1506, or select an IED from the drop down menu 1508. For example, the user interacting with the GUI 1500 has selected the SEL-321 IED from the drop down menu 1508. In this case, after the user selects the COPY TO IED 604 option, the learning-mimicking software 102 will scan the response for the “STA” command for occurrence of the text “SEL-321-1.” If software 102 finds an occurrence it will replace that text with the text “SEL-321.” The software will then copy the command and modified response record for the “STA” command from the SEL-321-1 to the SEL-321.

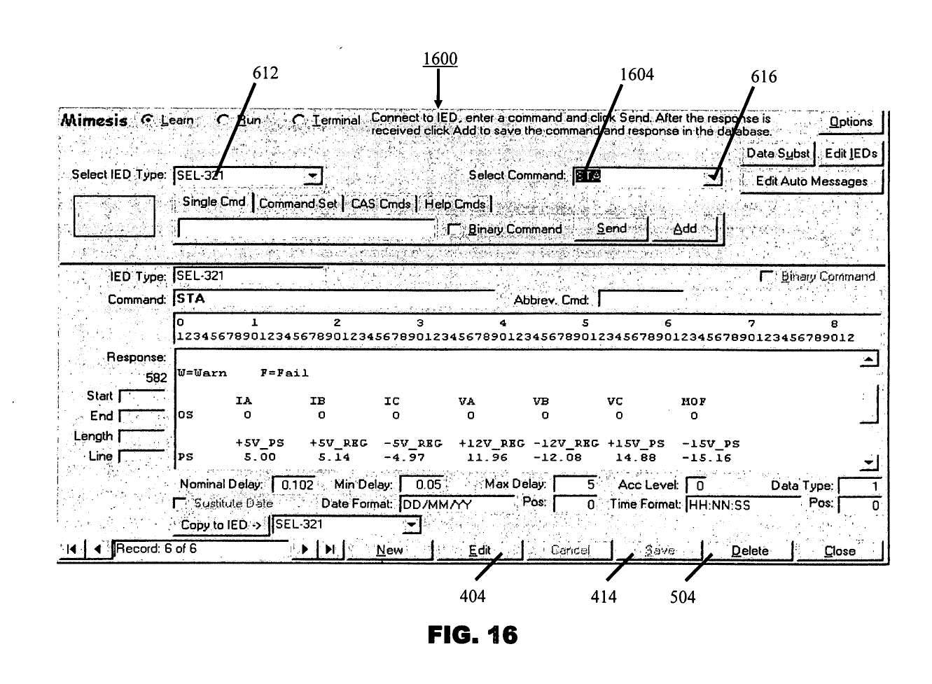

The GUI 1600 in FIG. 16 shows that the SEL-321, represented to the user in the SELECT IED TYPE text field 1602, now has the “STA” command 1604 copied in [0099]. The user may select this command by selecting it from the SELECT COMMAND drop down menu 616. The user may then modify the command and response record by using the EDIT 404, SAVE 414, or DELETE 504 options.

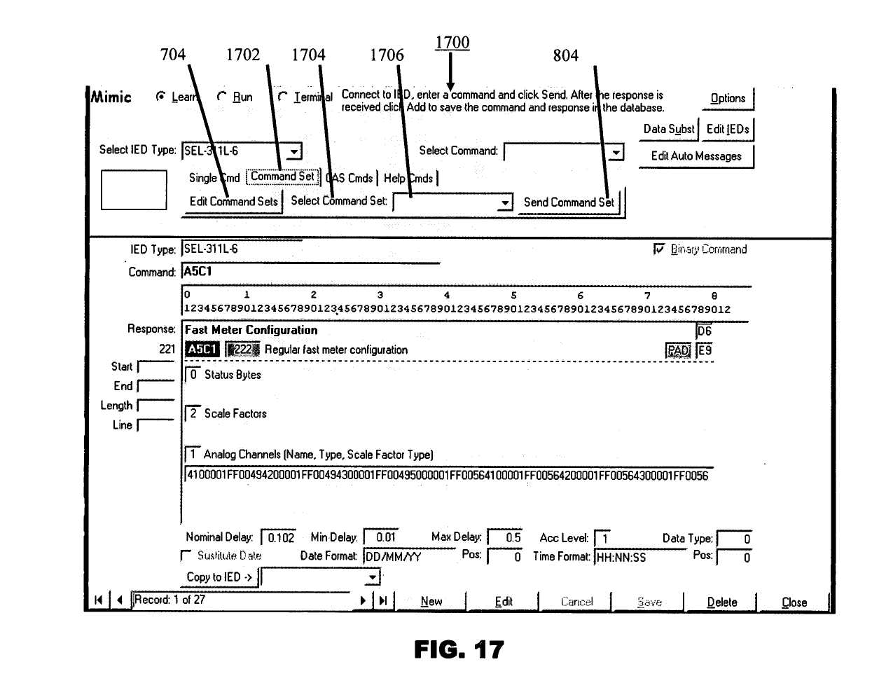

The GUI in FIG. 17 shows how a user would select the EDIT COMMAND SET 704 and SEND COMMAND SET 804 options. The user first selects the Command Set tab 1702, bringing forward the Select Command Set Menu 1704. If the user wishes to edit or send an existing Command Set, he must first select that Command Set from the drop down menu 1706 before selecting an option. If the user wants to create or send a new Command Set, then the user may then select the EDIT COMMAND SET 704 option or the SEND COMMAND SET 804 option.

If the user selects the EDIT COMMAND SET 704 option, the software 102 will open a new GUI 1800 as shown in FIG. 18. After the software 102 presents this screen, the user may select any of the following options: NEW 710, EDIT 732, CANCEL 724, DELETE 728, or CLOSE 738. If the user selects NEW 710 or EDIT 732, the software will place a cursor in the SetName 1802 text field. The user will then be able to edit the SetName 1802, Description 1804, and Log 1806 text fields. The user may then add commands and the commands' associated data to the Command Set 1808. Once the Command Set is created, the user may close this GUI 1800 by selecting the CLOSE 738 option.

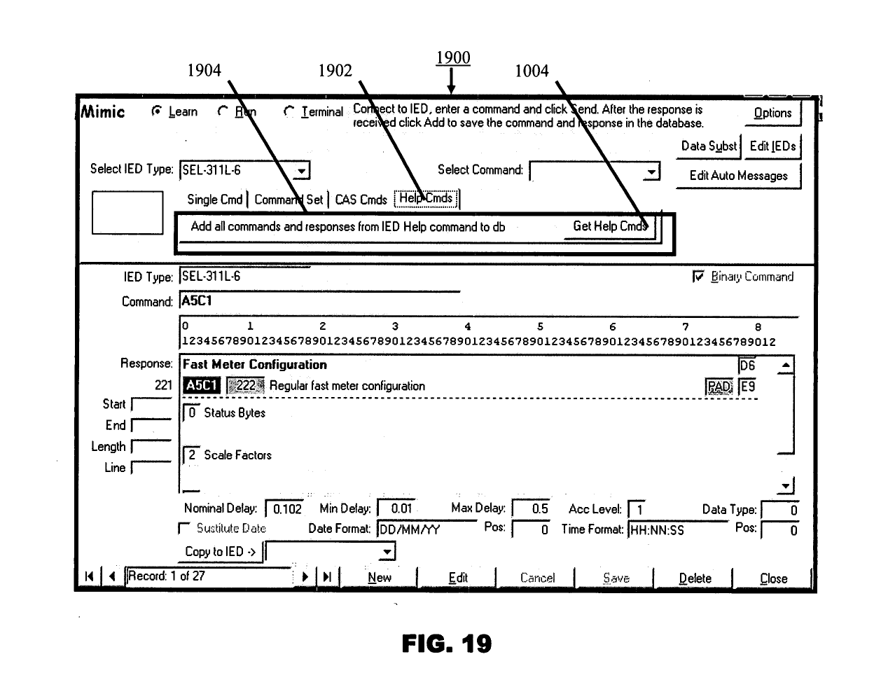

FIG. 19 demonstrates how a user would utilize the GET HELP CMDS 1004 option. The user must first select the Help Cmds tab 1902, bringing forward the Help Cmds menu 1904. The user may then select the GET HELP CMDS 1004 option.

After selecting the GET HELP CMDS 1004 option, the software 102 sends a specialized HELP command to the attached IED. If the IED accepts the HELP command, it will return a list of commands it recognizes. This list also contains short descriptions of each command. The software 102 will parse the list and create the GUI 2000 as demonstrated in FIG. 20. The commands 2002 received from the IED are displayed in ascending alphabetical order. Next to the commands are their respective descriptions 2004 received from the IED. The user may then select which commands to enter into the data storage 108 by checking the command's respective check box 2006. Once the user has selected those commands, the user may select OK 2008 to continue the GET HELP CMNDS process as shown in FIG. 10, or the user may cancel the process by selecting the CANCEL 2010 option.

After the learning-mimicking software 102 has learned the command and responses for a selected IED type, the software 102 is ready to mimic that IED via serial or Ethernet communications. In Run Mode, the learning-mimicking software 102 simply acts like the IED from a serial communications point of view. The software 102 is able to respond to serial commands similar to the IED.

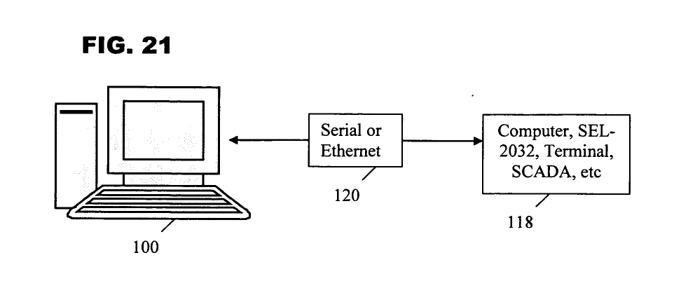

Referring to FIG. 21, the user may connect his computer 118 with some kind of serial program, such as proprietary software, a terminal emulator, or Telnet program, to the computer system 100 running the learning-mimicking software 102. This connection is established via serial or Ethernet communications 120. However, it is also possible for the user to utilize Run Mode on the system 100 running the learning-mimicking software 102. The system 100 does not have to be connected to an IED or another computer or system in order to mimic IED communications.

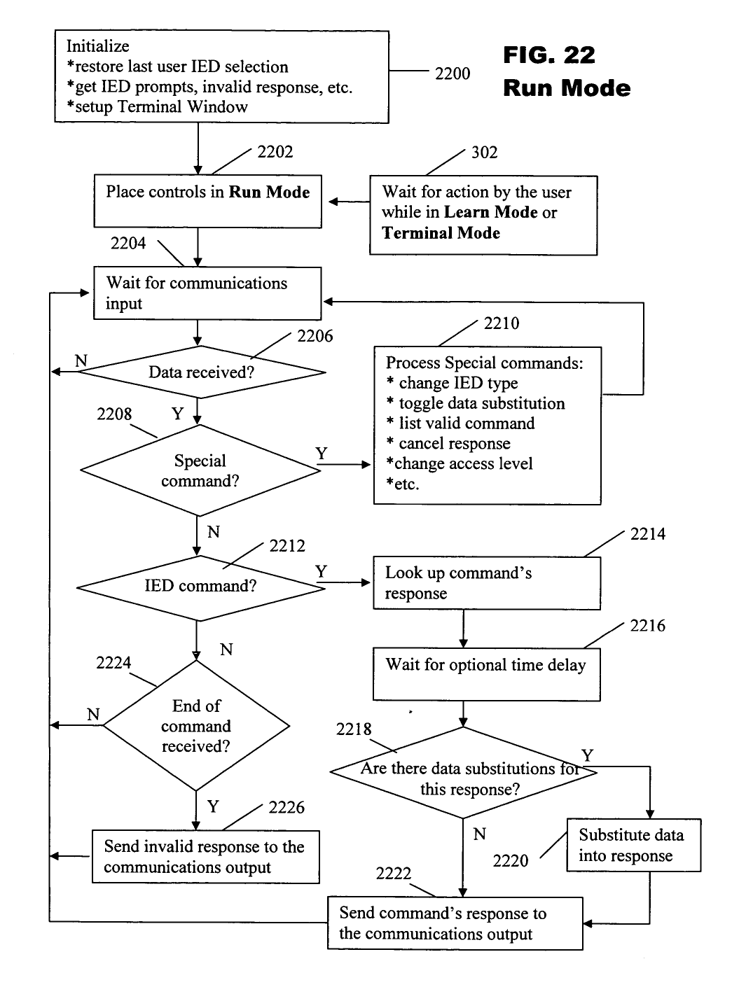

In FIG. 22, first the user turns on and initializes 2200 the system 100 running the learning-mimicking software 102. The software 102 then restores that user's last IED selection and retrieves the IED prompts, invalid responses, et cetera. Because, the user is typically interacting with the system 100 via a serial or Telnet communications, the user has to initialize that system and start the IED or external system.

Subsequently, the user may place the learning-mimicking software 102 in Run Mode 2202. If the user was operating the software 102 in Learn Mode 302, he may switch to Run Mode without having to reinitialize the software 102. After being placed in Run Mode, the software 102 waits for communications input from the external IED or system or from the communication input 2204. If the software 102 receives an input, for example via a virtual terminal, the software 102 determines whether it is the end of a command at 2224. If the data is not an end of a command, the software 102 will return to waiting for input 2204.

If the data is valid, the software 102 will check to determine whether the data contains a special command 2208. A special command is not an IED command, but a command that modifies the software 102 or the mimicking environment. For example, the user may want to mimic an IED other than the one he selected, in which case he may send a special command instructing the learning-mimicking software 102 to change the IED type being mimicked. In addition to the “change IED type” special command, the user, for instance, may toggle the data substitution mode on or off, ask for a list of valid commands associated with IED being emulated, cancel the response by the software 102, change the access level, et cetera 2210.

If the data does not contain a special command, the software 102 will determine whether the input by the user is an IED command 2212 by comparing the data received against commands already stored in the command and response records. If software 102 determines that the data represents an IED command, it will then look up the response associated with that command 2214 for the IED that is being mimicked. As described above, when a command and its response are captured in Learn Mode, the software 102 also records the nominal delay time and adds minimum and maximum reply delay times of the IED. Consequently, if the response looked up by the computer has a delay associated with it, then the software 102 will pause for the length of that delay 2216. The user may instruct the software 102 to pause for the Nominal, Minimum, Maximum and Random delay times.

Subsequently, the computer will determine if there are any data substitutions for the response 2218. As mentioned above, a data substitution replaces one or several recorded response values with variables and may be created in either Run Mode or Learn Mode. The variables will have a default value linked with them. These default values are set by the user when a new data substitution is created. However, the user in either Learn Mode or Run Mode may later manipulate the variables' values. The software 102 will substitute the saved values into the response.

After making the data substitution, the software 102 will then send the command's response to the communications output, where it will be passed via serial or Ethernet communications to the communication output 2222. If the user is using the host system 100 in Virtual Terminal Mode, then the response is displayed on the GUI rather than being sent to the communications output. Afterward, the learning-mimicking software 102 returns to waiting for communications input or input from a local user 2204. However, if there are no data substitutions linked with the response, then the software 102 will send the response as it was stored in the record.

If the data received from the communications input was not an IED command, then the software 102 determines whether the input signified the end of a command received 2224. If the input signified the end, and the software 102 does not recognize as special command or IED command, the software 102 then replies by sending a response to the communications output 2226 to inform the remote system or device (or user if in Virtual Terminal mode) that the data received was invalid. The software 102 will then return to waiting for communications input 2204.

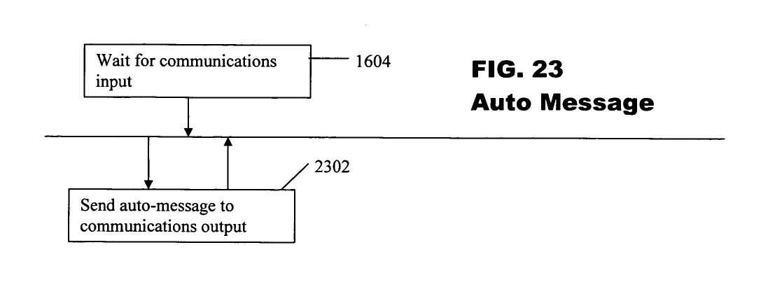

As shown in FIG. 23, in Run Mode, the software 102 may also periodically send an auto-message to the communications output 2302. This action, for example, may mimic an IED's periodic output of a new event or status report.

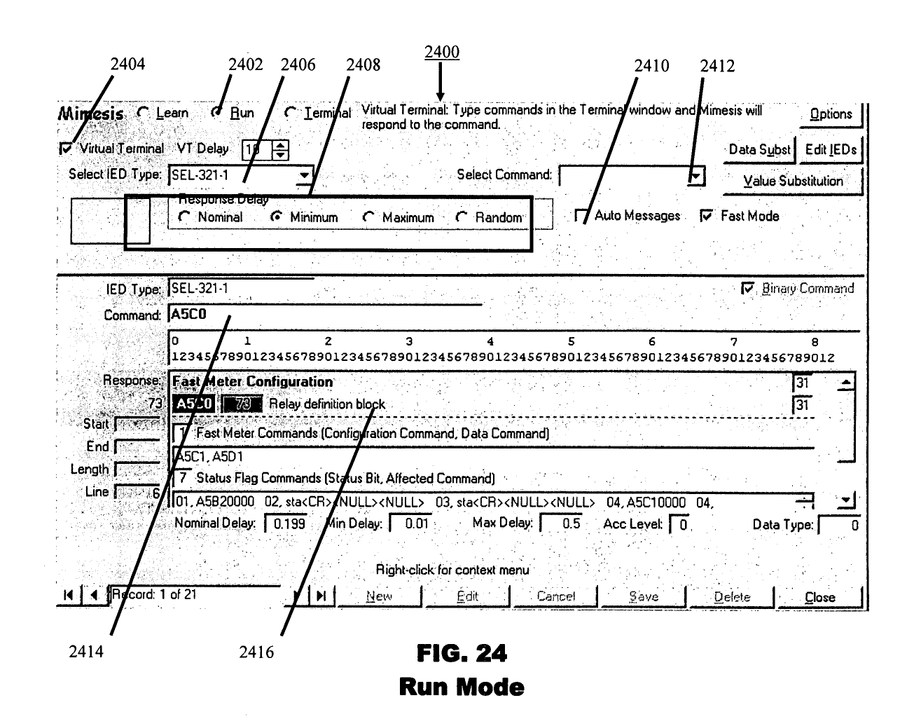

FIGS. 24-28 are representative GUIs or forms created by learning-mimicking software 102 while operating in Run Mode. In these examples, no IED, other PC, or serial communications were actually used. The user is local and directly interacting with the system 100 and the software 102. In Run Mode, the application is ready to mimic the selected IED type via serial or Telnet communications or via a Virtual Terminal. FIG. 24 is an example of the main interface GUI 2400 created by the software 102 when it is placed into Run Mode. In this example, the user has selected to operate the program in Run Mode by choosing the RUN MODE 2402 option.

The user interacting with the GUI 2400 chose to mimic the SEL-321-1 IED by selecting it from the drop down menu 2406. The user may also select from four possible response delays 2408. For example, the user has instructed the software 102 to use the minimum delay associated with each command. The user may have also selected the AUTO MESSAGE 2410 option, to mimic the SEL-321-1 IED's auto-messaging outputs.

The user may then select a command to view from the drop down menu 2412. The software will then retrieve the response associated with the command selected by the user. The software will then display the command in the COMMAND field 2414 and the response in the RESPONSE field 2416.

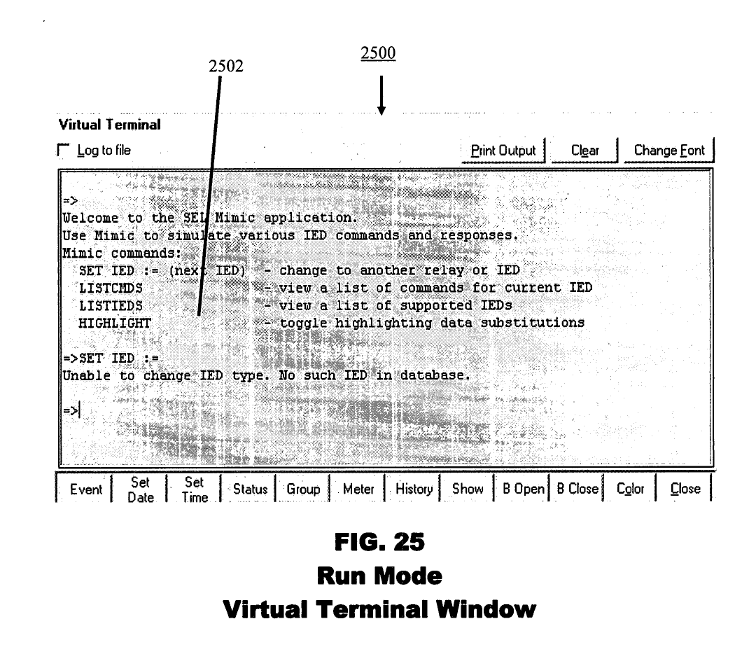

In this example, the user has also placed the program into virtual terminal mode by selecting the VIRTUAL TERMINAL 2404 option. When this option is selected, the software 102 creates another GUI 2500 as shown in FIG. 25. The user enters the commands in the Terminal text field 2502, and the software 102 returns the corresponding response from the data storage to Terminal text field 2502 of the GUI 2500.

Responses may also include data value substitutions. As demonstrated in FIG. 26, these substitutions 2602 may optionally appear highlighted or underlined in the RESPONSE text field 2600 to make it obvious which fields the substitutions occur. Fields subject to a data substitution may also appear highlighted in the Virtual Terminal.

FIG. 27 shows how a user may create a data substitution for a response value. First, the user must select the IED and a specific command associated with that IED. The response linked to that command may then be modified by replacing the specific values with fields that may later be modified. In the GUI 2700, for example, the user has selected the SEL-487B IED from the SELECT IED TYPE drop down menu 2702 and the “MET” command from the SELECT COMMAND drop down menu 2704. The software 102 then displayed the response associated with the “MET” command for the SEL-487B IED in the RESPONSE text field 2706. The user selected the area 2708 of the response where he wanted to substitute the specific value, in this case the value “−76.08.” The user then instructed the software 102 to add a new data substitution by opening a separate menu and selecting ADD NEW DATA SUBSTITUTION 514.

FIG. 28 shows the GUI 2800 opened by the user's selection of ADD NEW DATA SUBSTITUTION 514. The software automatically places the appropriate IED type and the IED command in the IED TYPE text field 2802 and IED COMMAND text field 2804. For instance, because the response of the “MET” command for the SEL-487B is being modified, the software 102 placed “SEL-487B” in the IED TYPE text field 2802 and “MET” in the IED COMMAND text field 2804. The user then entered “IA-Mag” in the DATA LABEL text field 2806 as a label for variable being created by the data substitution. The user then entered the information relating to the Data Type in the DATA TYPE text field 2808. In this example, the user also instructed the software 102 to use “0.486” as the default value for the data substitution by entering that value into the DEFAULT VALUE text field 2810. Consequently, software 102 will substitute this value into the area 2708 originally selected by the user, unless the user specifies a different value. The user also entered information relating to the data precision, number of characters, and response offset in their respective text fields DATA PRECISION 2812, NUMBER OF CHARACTERS 2814, and RESPONSE OFFSET 2816. The response offset and number of characters are automatically inserted based on the user's selection, but may be edited.

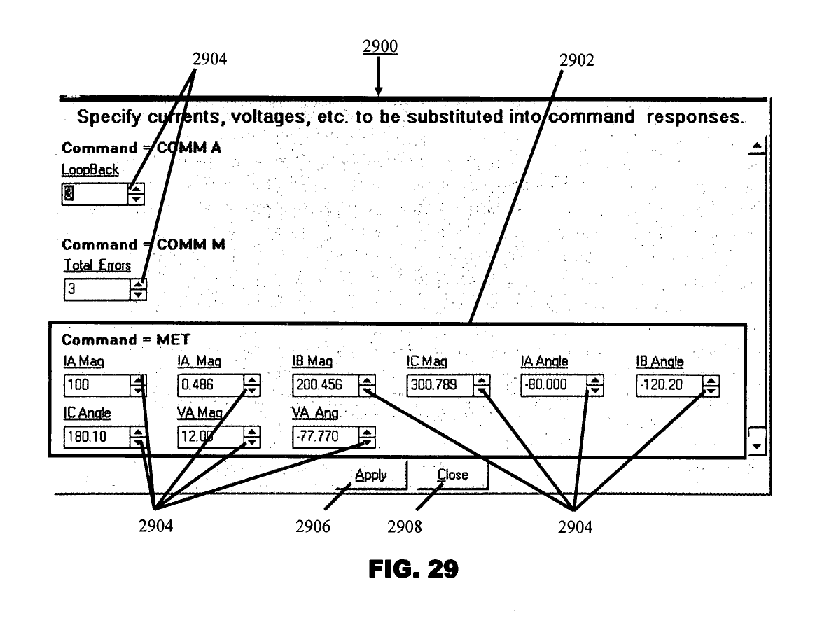

Once the substitution record is created, the user may adjust any value using another form by either selecting the DATA SUBST 2710 option, which displays the data in a table, or by selecting the VALUE SUBSTITUTION 2712 option as shown in FIG. 27. For example, if the user selected the VALUE SUBSTITUTION option, he would be presented with the GUI 2900 as shown in FIG. 29. The variables associated with the SEL-487B IED are presented 2900, including those associated with the “MET” command 2902. The user may then increase or decrease the values of these variables by using the up-and-down arrows 2904 to the right of the text fields. Once completed, the user may apply the modifications by selecting the APPLY 2906 option or cancel the modifications by selecting the CLOSE 2908 option. If the user accepts the modifications, those values the user selected will subsequently appear in the RESPONSE field 2706 when the “MET” command is selected and the data substitution is turned on.

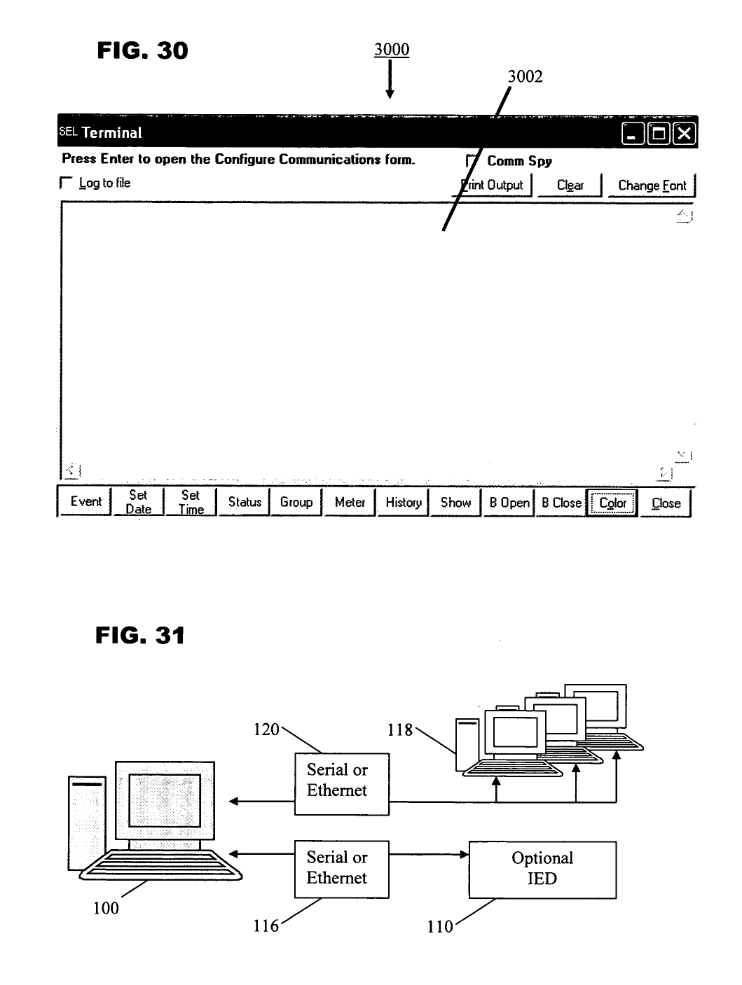

The final mode of operation is Terminal Mode. As shown in FIG. 30, Terminal mode opens an optional terminal. The user may utilize this mode and terminal communications to directly interact with the connected IED 110 or external system. The software 102 does not record any response returned to the terminal window 3002.

The combination of the learning-mimicking software 102 and the system 100 has several possible applications. The ADD DATA SUBSTITUTION 514 option allows users to perform some system tests without actually having the IED present. The user may enter specific values in place of the variables and then test the system as these are collected via various commands on external systems.

A panel builder or system integrator may purchase and use the learning-mimicking software 102 to perform integration with numerous IEDs without having to purchase the actual IEDs. System integrators could interface various IEDs, such as relays, meters, RTUs, et cetera, with communication processors without actually having the IEDs present and connected.

Another application that the software 102 allows is the training of new employees without having to provide numerous IEDs. Sales people may also take advantage of the Run Mode by demonstrating to potential customers new IEDs or IEDs that have not yet been physically constructed. These features are demonstrated in FIG. 31. Multiple users 118 can connect to the system 100 by serial or Ethernet communications 120. The users 118 can then interact with the system 100 as if they were interacting with the IED being mimicked. Multiple users may run multiple copies of the software and share the same data storage. The communication networks 116 and 120 may be combined into a single network, which users may use to connect to the system 100 and for the system 100 to connect to the IED.

Specification writers may specify commands and responses for new or improved IEDs using the software 102. They may collaborate by sharing the system's 100 data storage 108 over a LAN or Ethernet 120. Database reports may easily be generated for documentation purposes. Records containing IED commands may be approved and then locked from modification.

Test authors may also create tests (including automated tests) that send serial commands to the learning-mimicking software 102 to check the responses. Once the actual IED is available, the test authors may run the same tests with the IED and compare the response. This would allow the test authors to easily determine whether the IED manufacture followed the specifications of the IED.

1. A data processing system for mimicking the communications output of an intelligent electronic device (IED), said system comprising:
a data processor;
a user interface for entry of commands or data into the data processing system by a user; and
user interface software executable by said data processor,
said user interface software including or interacting with learning software to learn commands sent to said IED and their corresponding responses received from said IED,
said user interface software further including or interacting with mimicking software, said mimicking software accepting commands and inputs from the interface software, said mimicking software returning the responses corresponding with the commands to mimic, whereby the mimicking software imitates the communications, signals, output, or responses of said IED.

2. The data processing system in accordance with claim 1 wherein
said learning software communicates or interacts with said IED that is attached to the data processing system.

3. The data processing system in accordance with claim 2 wherein
said learning software receives IED commands from the interface software and sends said IED commands to said IED.

4. The data processing system in accordance with claim 3 wherein
said learning software receives signals, communications, responses, and/or outputs from said IED.

5. The data processing system in accordance with claim 4 wherein
said learning software stores the inputs from the interface software and the corresponding signals, communications, responses and/or outputs received from said IED.

6. The data processing system in accordance with claim 5 wherein
said learning software stores said corresponding communications, signals, responses and/or outputs as digital representations.

7. The data processing system in accordance with claim 5 wherein
said learning software allows a user of said data processing system to edit the stored input and the corresponding communications, signals, responses, and/or outputs received from said IED.

8. The data processing system in accordance with claim 5 wherein
said learning software allows a user of said data processing system to perform a data substitution within the stored input and within the corresponding communications, signals, responses, and/or outputs.

9. The data processing system in accordance with claim 8 wherein
said data substitution involves replacing data or signals within the stored response with a variable,
said variable being manipulable by either said learning software or a by the user of said data processing system.

10. The data processing system in accordance with claim 4 wherein
said learning software accepts a list representing a plurality of commands from the user of the data processing system.

11. The data processing system in accordance with claim 10 wherein
said learning software transmits said list representing a plurality of different commands to said IED.

12. The data processing system in accordance with claim 11 wherein
said learning software receives and stores communications, signals, responses, and/or outputs received from said attached IED representing the responses of the IED to the transmission of said list.

13. The data processing system in accordance with claim 2 wherein
said learning software sends specialized commands to elicit from said IED a list of commands associated with that IED.

14. The data processing system in accordance with claim 13 wherein
said learning software receives a list of commands elicited from said IED.

15. The data processing system in accordance with claim 14 wherein
said learning software parses said list of commands elicited from said IED.

16. The data processing system in accordance with claim 15 wherein
said learning software sends to said IED a command from said parsed list of commands.

17. The data processing system in accordance with claim 16 wherein
said learning software allows the user to select which commands to send to said IED.

18. The data processing system in accordance with claim 1 wherein
said mimicking software mimics the communications, signals, responses, and/or outputs generated by said IED by displaying a representation of said communications, signals, responses, and/or outputs on said user interface.

19. The data processing system in accordance with claim 1 wherein
said mimicking software returns the responses to said commands to mimic by displaying a representation of the communications, signals, responses, and/or outputs generated by said IED on said user interface.

20. The data processing system in accordance with claim 1 wherein
said mimicking software returns the responses by generating communications, signals, responses, and/or outputs using serial or Ethernet communications.

21. A data processing system for mimicking the communications output of an intelligent electronic device (IED), said data processing system comprising:
means for interacting with the user of the data processing system;
means for recording the communications, signals, responses, and/or outputs of an IED and;
means for mimicking said communications, signals, responses, and/or outputs of said IED.

22. The data processing system in accordance with claim 21 wherein
said means for interacting with the user includes a means for the user of the data processing system to input an IED command.

23. The data processing system in accordance with claim 22 further comprising:
a means for transmitting said IED command from the data processing system to an IED.

24. The data processing system in accordance with claim 23 further comprising:
a means for receiving communications, signals, responses, and/or outputs from an IED in response to the transmittal of said IED command.

25. The data processing system in accordance with claim 24 wherein
said means for accepting IED commands is software executed by the data processing system.

26. The data processing system in accordance with claim 24 wherein
said means for transmitting the IED commands and for receiving communications, signals, responses, and/or outputs from an IED utilizes serial or Ethernet communications.

27. The data processing system in accordance with claim 25 further comprising:
a means for storing the IED commands inputted by the user of the data processing system and the corresponding communications, signals, responses, and/or outputs received from an IED.

28. The data processing system in accordance with claim 27 wherein
said means for storing employs digital representations of the IED commands and the corresponding communications, signals, responses, and/or outputs received from an IED.

29. The data processing system in accordance with claim 27 further comprising:
a means for allowing the user of said data processing system to edit the stored inputted IED commands and the corresponding communications, signals, responses, and/or outputs received from an IED.

30. The data processing system in accordance with claim 27 further comprising:
a means for performing a data substitution of the stored commands or the corresponding communications, signals, responses, and/or outputs received from an IED.

31. The data processing system in accordance with claim 30 wherein
said means for performing a data substitution involves replacing data or signals within the stored response with a variable,
said variable being manipulable by either the user of said data processing system.

32. The data processing system in accordance with claim 24 further comprising:
a means for accepting a list from the user data processing system representing a plurality of commands.

33. The data processing system in accordance with claim 32 further comprising:
a means for transmitting said list or the individual commands represent by said list to an IED connected to the data processing system.

34. The data processing system in accordance with claim 33 further comprising:
a means for receiving and storing the individual responses of said IED to each command represented in said list.

35. The data processing system in accordance with claim 24 further comprising:
a means for sending specialized commands to elicit from an IED attached to the data processing system a list of commands associated with said IED.

36. The data processing system in accordance with claim 35 further comprising:
a means for parsing said list of commands.

37. The data processing system in accordance with claim 36 further comprising:
a means for sending to said IED a command from said parsed list of commands.

38. The data processing system in accordance with claim 37 further comprising:
a means to allow the user to select which commands from the parsed list of commands to send to said IED.

39. The data processing system in accordance with claim 21 wherein
said means for mimicking the communications, signals, responses, and/or outputs generated by an IED includes a means for displaying a representation of said communications, signals, responses, and/or outputs on a user interface.

40. The data processing system in accordance with claim 21 wherein
said means for mimicking the communications, signals, responses, and/or outputs generated by an IED includes a means for generating a representation of the communications, signals, responses, and/or outputs of said IED by using serial or Ethernet communications.

41. The data processing system in accordance with claim 21 wherein
said means for mimicking the communications, signals, responses, and/or outputs generated by an IED includes a means for generating the communications, signals, responses, and/or outputs of said IED using serial or Ethernet communications.

42. A method for mimicking an intelligent electronic device (IED) by a data processing system, the data processing system including memory, a data processor, data storage, a user interface and software, the data processing system also configured to communicate with said IED, the method comprising the steps of:
receiving from the user input information at the user interface in the form of an IED command;
sending said IED command and/or data to an IED;
recording the response to the command from said IED;
receiving from the user or external system an IED command to mimic; and
retrieving from data storage or memory the response associated with said IED command to be mimicked.

43. A computer readable medium having program code recorded thereon, for execution on a computer having a graphical user interface and a user input device, to mimic the communications, signals, responses and/or outputs of an intelligent electronic device (IED), comprising:
a first program code for receiving instructions or commands from a user input device;
a second program code for recording the communications, signals, responses and/or outputs generated by an IED;
a third program code for mimicking the communications, signals, responses and/or outputs generated by an IED.

44. A data processing system for mimicking the communications output of an intelligent electronic device (IED), said system comprising:
a data processor;
a user interface for entry of commands or data into the data processing system by a user, and user interface software executable by said data processor,
said user interface software including or interacting with learning software to learn commands sent to said IED
said learning software directing said data processor to communicate with an IED attached to said data processor,
said learning software directing said data processor to transmit said commands to said IED,
said learning software directing said data processor to receive the responses and/or signals from said IED,
said learning software directing said data processor to store said commands and their corresponding responses and/or signals from said IED,
said data processor being in communication with or adapted to utilize a data storage unit
said learning software and said interface software directing said data processor to store the commands sent to said IED and their said corresponding responses and/or signals received from said IED.
said user interface software also including mimicking software,
said mimicking software directing said data processor to accept commands or input from the interface software of said data processor.
said mimicking software directing said data processor to search said storage unit for the response corresponding to said command received by the mimicking software,
said mimicking software directing said data processor to return the response to the said user interface, whereby the mimicking software mimics the signals and communications of said IED without requiring special hardware or the physical presence of an IED.
